(19) United States
(12) Patent Application Publication
(10) Pub. No.: US 2024/0170020 A1
(43) Pub. Date: May 23, 2024

(54) TAPE CARTRIDGE, METHOD OF PRODUCING TAPE CARTRIDGE, AND TAPE REEL

(71) Applicant: Sony Group Corporation, Tokyo (JP)

(72) Inventors: Yuji IWAHASHI, Tokyo (JP); Minoru YAMAGA, Tokyo (JP); Kazumoto YATABE, Tokyo (JP)

(21) Appl. No.: 18/284,013

(22) PCT Filed: Feb. 28, 2022
(86) PCT No.: PCT/JP2022/008221

§ 371 Date: Sep. 25, 2023

(30) Foreign Application Priority Data
Mar. 26, 2021 (JP) 2021-053469

(51) Int. Cl. G11B 23/087; G11B 23/113

(52) U.S. Cl. CPC G11B 23/08728; G11B 23/08757; G11B 23/113

(57) ABSTRACT

A tape cartridge according to an embodiment of the present technology includes: a first tape reel; a magnetic tape; a leader pin; and a second tape reel. The magnetic tape is wound around the first tape reel. The leader pin is attached to an end portion of the magnetic tape and includes a shaft portion parallel to a tape width direction. The second tape reel includes a cylindrical reel hub, a first flange, and a second flange. The reel hub has an inner peripheral surface and an outer peripheral surface, a housing unit capable of housing the leader pin being provided on the inner peripheral surface or the outer peripheral surface. The first flange is provided to one end portion of the reel hub. The second flange is provided to the other end portion of the reel hub and includes a slit portion through which the magnetic tape is capable of passing.

### TECHNICAL FIELD

The present technology relates to a two-reel tape cartridge, a method of producing the same, and a tape reel.

### BACKGROUND ART

The two-reel tape cartridge includes two tape reels rotatably housed inside a cartridge case. One of the two tape reels is called a supply reel on which a magnetic tape is wound, and the other is also called a take-up reel that takes up a magnetic tape. When both ends of the magnetic tape in the length direction are fixed to the respective reel hubs of the supply reel and the take-up reel using a fixing member such as a clamper, the magnetic tape is supported between the two tape reels so as to be capable of travelling over the entire length (see, for example, Patent Literature 1).

### CITATION LIST

### Patent Literature

Patent Literature 1: Japanese Patent Application Laid-open No. 2005-317055

### DISCLOSURE OF INVENTION

### Technical Problem

In the structure in which a fixing means such as a clamper is used to fix the end portion of the magnetic tape to the outer peripheral surface of the reel hub as described in Patent Literature 1, a step generated between the outer peripheral surface of the reel hub and the surface of the clamper is transferred to the magnetic tape, which adversely affects the magnetic layer of the magnetic tape in some cases. In particular, in recent years, since the thickness of the magnetic tape has been reduced and the deformation of the magnetic tape due to the step generated on the outer peripheral surface of the reel hub has become more pronounced, there is a demand to make the step smaller.

In view of the circumstances as described above, it is an object of the present technology to provide a tape cartridge, a method of producing the same, and a tape reel, which are capable of reducing the step generated on the outer peripheral surface of the reel hub.

### Solution to Problem

A tape cartridge according to an embodiment of the present technology includes: a first tape reel; a magnetic tape; a leader pin; and a second tape reel. The magnetic tape is wound around the first tape reel.

The leader pin is attached to an end portion of the magnetic tape and includes a shaft portion parallel to a tape width direction.

The second tape reel includes a cylindrical reel hub, a first flange, and a second flange. The reel hub has an inner peripheral surface and an outer peripheral surface, a housing unit capable of housing the leader pin being provided on the inner peripheral surface or the outer peripheral surface. The first flange is provided to one end portion of the reel hub. The second flange is provided to the other end portion of the reel hub and includes a slit portion through which the magnetic tape is capable of passing.

A method of producing a tape cartridge according to an embodiment of the present technology includes:
winding a magnetic tape around a first tape reel;
disposing the magnetic tape between a first flange portion and a second flange portion of a second tape reel through a slit portion formed in the first flange portion;
housing a leader pin in a housing unit formed on an inner peripheral surface or an outer peripheral surface of a reel hub of the second tape reel, the leader pin being attached to an end portion of the magnetic tape; and
winding the magnetic tape around the reel hub of the second tape reel.

A tape reel according to an embodiment of the present technology includes: a reel hub; a first flange; and a second flange.

The reel hub has an inner peripheral surface and an outer peripheral surface, a housing unit capable of housing a leader pin being provided on the inner peripheral surface or the outer peripheral surface, the leader pin being attached to an end portion of a magnetic tape.

The first flange is provided to one end portion of the reel hub.

The second flange is provided to the other end portion of the reel hub and includes a slit portion through which the magnetic tape is capable of passing.

### BRIEF DESCRIPTION OF DRAWINGS

FIG. 1 is a schematic perspective view showing a tape cartridge according to an embodiment of the present technology.

FIG. 2 is a plan view of a first tape reel.

FIG. 3 is a cross-sectional side view of a first tape reel.

FIG. 4 is a schematic diagram of a magnetic tape viewed from the side.

FIG. 5 is a plan view of a second tape reel to which a leader pin is attached.

FIG. 6 is a cross-sectional side view of the second tape reel.

FIG. 7 is an enlarged plan view of a main part of a reel hub showing details of a housing unit in the second tape reel.

FIG. 8 is a cross-sectional side view of FIG. 7.

FIG. 9 is a plan view of a second tape reel according to another embodiment.

FIG. 10 is a cross-sectional side view of FIG. 9.

FIG. 11 is an enlarged plan view of a main part of a reel hub in the second tape reel.

FIG. 12 is a plan view of the reel hub showing how a magnetic tape 1 is wound.

FIG. 13 is a cross-sectional side view of a main part of a tape cartridge according to another embodiment of the present technology.

FIG. 14 is an explanatory diagram of the particle shape of hexagonal ferrite that is a magnetic powder.

### MODE(S) FOR CARRYING OUT THE INVENTION

Hereinafter, an embodiment according to the present technology will be described with reference to the drawings.

### First Embodiment

[Tape Cartridge]

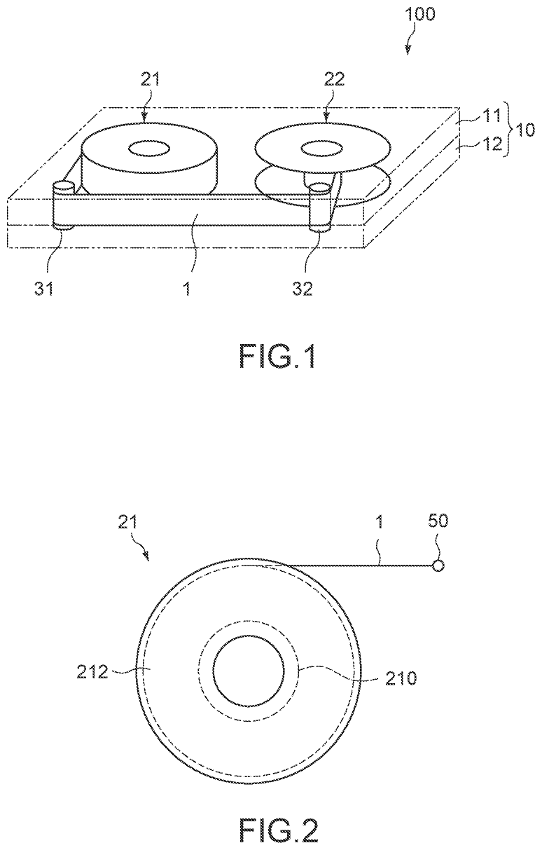

FIG. 1 is a schematic perspective view showing a tape cartridge 100 according to an embodiment of the present technology. The tape cartridge 100 includes a cartridge case 10, a first tape reel 21, and a second tape reel 22.

The cartridge case 10 has a rectangular parallelepiped shape and has a two-part structure of an upper shell 11 and a lower shell 12 having a shallow dish shape. The upper shell 11 and the lower shell 12 are typically formed by an injection molded body of a synthetic resin material and are connected to each other using a plurality of screws or the like.

The first tape reel 21 and the second tape reel 22 are rotatably housed inside the cartridge case 10. The first tape reel 21 is a supply reel around which a magnetic tape 1 is wound, and the second tape reel 22 is a take-up reel capable of taking up the magnetic tape 1 wound around the first tape reel 21. A pair of guide pins 31 and 32 that guide the travelling of the magnetic tape 1 between the first tape reel 21 and the second tape reel 22 are disposed inside the cartridge case 10.

The tape cartridge 100 according to this embodiment has, for example, a lid mechanism that is opened when the tape cartridge 100 is loaded into a recording/reproducing drive apparatus (illustration omitted) and the magnetic tape 1 is loaded into the recording/reproduction apparatus. The recording/reproduction apparatus includes a reel drive shaft that causes the first and second tape reels 21 and 22 to rotate, a drive head that records and reproduces information on/from the magnetic tape 1 loaded by the tape cartridge 100, and the like.

Alternatively, the tape cartridge 100 according to this embodiment may further include a recording/reproducing drive head disposed inside the cartridge case 10. The drive head is disposed, for example, at a position facing the magnetic layer of the magnetic tape 1 spanned between the pair of guide pins 31 and 32. In this case, the tape cartridge 100 is loaded into the drive apparatus including a reel drive shaft that causes the first and second tape reels 21 and 22 to rotate, and information is recorded and reproduced on/from the magnetic tape 1 by the drive head.

Subsequently, details of the first tape reel 21 and the second tape reel 22 will be described.

[First Tape Reel]

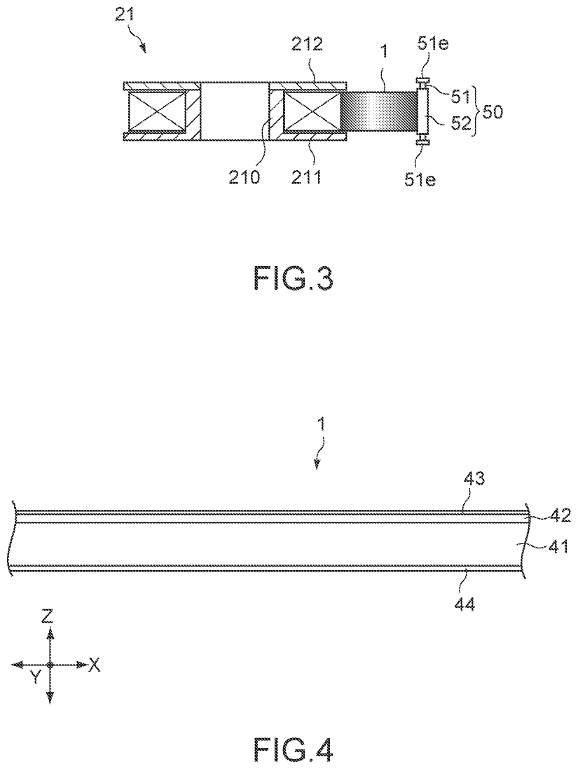

FIG. 2 is a plan view of the first tape reel 21, and FIG. 3 is a cross-sectional side view of the first tape reel 21.

The first tape reel 21 includes a cylindrical reel hub 210, a disk-shaped lower flange 211 integrally formed in the lower end portion of the reel hub 210, and a disk-shaped upper flange 212 joined to the upper end portion of the reel hub 210 by ultrasonic welding or the like. The upper flange 212 may be integrally molded with the reel hub 210. An engaging portion (illustration omitted) that engages with the reel drive shaft of the drive apparatus is provided on the inner peripheral surface or the bottom surface of the reel hub 210.

The reel hub 210 and the lower flange 211 are integrally molded using a synthetic resin material such as PC (polycarbonate) and ABS (acrylonitrile-butadiene-styrene). Similarly, the upper flange 212 is also molded using a synthetic resin material such as PC and ABS. As the molding material of the reel hub 210 and the lower flange 211, a composite material obtained by adding an inorganic filler such as a glass filler to the synthetic resin material described above may be used for the purpose of improving strength.

Note that in the case where the upper flange 212 is integrally molded with the reel hub 210, similarly, the reel hub 210, the lower flange 211, and the upper flange 212 may be integrally molded using a synthetic resin material such as PC and ABS and a composite material obtained by adding the inorganic filler to the synthetic resin material may be used as the resin material.

The magnetic tape 1 is wound around the outer peripheral surface of the reel hub 210. The magnetic tape 1 is wound around the reel hub 210 after the end portion of the magnetic tape 1 on the winding start side (inner peripheral side) is temporarily fixed to the outer peripheral surface of the reel hub 210 using an appropriate volatile liquid such as alcohol. The length of the magnetic tape 1 is not particularly limited, and is, for example, 300 m or more and 1500 m or less.

As shown in FIG. 2 and FIG. 3, a leader pin 50 is attached to the tip portion (end portion on the winding end side (outer periphery side)) of the magnetic tape 1 wound around the reel hub 210. As shown in FIG. 3, the leader pin 50 includes a shaft portion 51 parallel to the tape width direction of the magnetic tape 1 (up-and-down direction in the figure) and a clamp member 52 for fixing the tip of the magnetic tape 1 to the shaft portion 51.

The shaft portion 51 is a metal part having a length greater than the tape width of the magnetic tape 1 and disk-shaped enlarged diameter portions 51e are provided at both end portions thereof. The enlarged diameter portion 51e has an outer diameter larger than the diameter of the shaft portion 51. The clamp member 52 is a part that is formed of a synthetic resin and has a length larger than the tape width of the magnetic tape 1 and shorter than the shaft portion 51, and is formed in a partial cylindrical shape of a substantially C-shaped cross section having a notch parallel to the shaft portion 51. The clamp member 52 is attached to the shaft portion 51 with the tip portion of the magnetic tape 1 sandwiched therebetween.

FIG. 4 is a schematic diagram of the magnetic tape 1 viewed from the side. As shown in FIG. 4, the magnetic tape 1 is formed in a tape shape that is long in the longitudinal direction (X-axis direction), short in the width direction (Y-axis direction), and thin in the thickness direction (Z-axis direction). The magnetic tape 1 includes a tape-shaped base material 41 that is long in the longitudinal direction (X-axis direction), an underlayer (non-magnetic layer) 42 provided on one main surface of the base material 41, a magnetic layer 43 provided on the underlayer 42, and a back layer 44 provided on the other main surface of the base material 41. Note that the back layer 44 only needs to be provided as required and this back layer 44 may be omitted. The magnetic tape 1 may be a magnetic recording medium of a perpendicular recording type or may be a magnetic recording medium of a longitudinal recording type. Note that details of the magnetic tape 1 will be described below.

[Second Tape Reel]

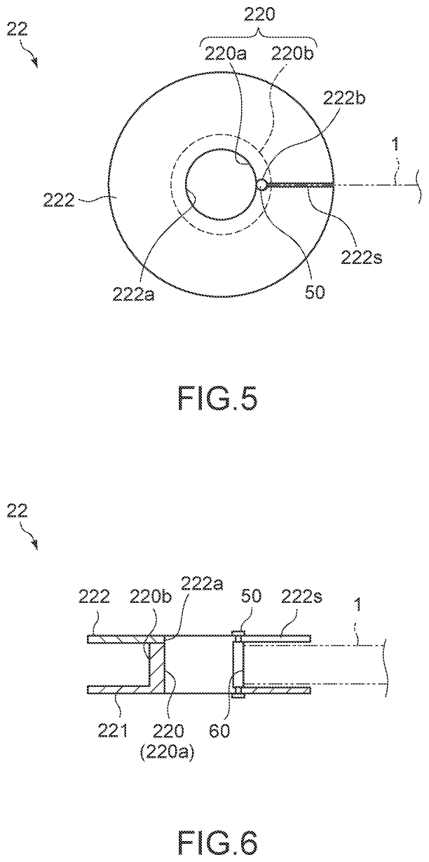

Next, the second tape reel 22 will be described. FIG. 5 is a plan view of the second tape reel 22 to which the leader pin 50 is attached, and FIG. 6 is a cross-sectional side view of FIG. 5.

The second tape reel 22 according to this embodiment includes a cylindrical the reel hub 220, a disk-shaped lower flange 221 (first flange) provided to one end portion (lower end portion) of the reel hub 220, and a disk-shaped upper flange 222 (second flange) provided to the other end portion (upper end portion) of the reel hub 220, similarly to the first tape reel 21. An engaging portion (illustration omitted) that engages with the reel drive shaft of the drive apparatus is provided on the inner peripheral surface or the bottom surface of the reel hub 220.

The upper flange 222 includes a central hole 222a concentric with the reel hub 220 and a slit portion 222s through which the magnetic tape 1 is capable of passing. The central hole 222a has an inner diameter substantially the same as the inner diameter of the reel hub 220. The slit portion 222s is linearly formed in the radial direction from the central hole 222a to the outer peripheral edge portion of the upper flange 222. An opening 222b for housing the upper end portion of the leader pin 50 is provided to the end portion of the slit portion 222s on the side of the central hole 222a.

The reel hub 220 and the lower flange 221 are integrally molded using a synthetic resin material such as PC (polycarbonate) and ABS (acrylonitrile-butadiene-styrene). As the molding material of the reel hub 220 and the lower flange 221, a composite material obtained by adding an inorganic filler such as a glass filler to the synthetic resin material may be used for the purpose of improving strength.

Similarly, the upper flange 222 is also molded using a synthetic resin material such as PC and ABS. The upper flange 222 is joined to the upper end portion of the reel hub 220 by ultrasonic welding or the like. The reel hub 220, the lower flange 221, and the upper flange 222 are respectively formed to have the same size as those of the reel hub 210, the lower flange 211, and the upper flange 212 of the first tape reel 21.

The reel hub 220 has an inner peripheral surface 220a and an outer peripheral surface 220b, and a housing unit 60 capable of housing the leader pin 50 is provided on the inner peripheral surface 220a. The housing unit 60 positions the leader pin 50 attached to the tip of the magnetic tape 1 to the reel hub 220 and allows the magnetic tape 1 to be wound around the outer peripheral surface 220b of the reel hub 220 by rotation of the second tape reel 22.

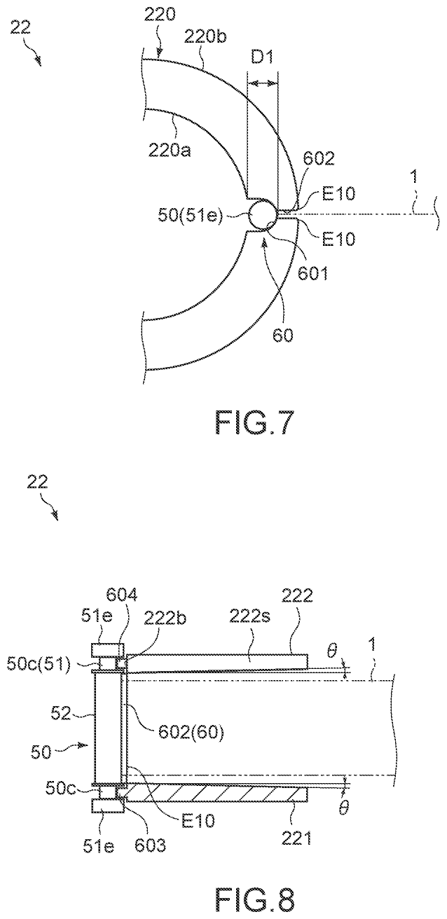

FIG. 7 is an enlarged plan view of a main part of the reel hub 220 showing details of the housing unit 60, and FIG. 8 is a cross-sectional side view of FIG. 7.

As shown in FIG. 7, the housing unit 60 includes a partially cylindrical recessed groove portion 601 that supports the leader pin 50, which is formed along the axial direction of the reel hub 220 on the inner peripheral surface 220a of the reel hub 220. The bottom portion of the recessed groove portion 601 is formed in a shape corresponding to the outer peripheral surface of the clamp member 52 of the leader pin 50 and positions the leader pin 50 in the circumferential direction of the reel hub 220. The recessed groove portion 601 is provided at a position facing the opening 222b of the upper flange 222 in the axial direction.

The housing unit 60 is formed to have a depth D1 larger than the maximum outer diameter of the leader pin 50. In this embodiment, the maximum outer diameter of the leader pin 50 corresponds to the outer diameter of the enlarged diameter portions 51e (see FIG. 3) provided at both end portions of the shaft portion 51. Since the housing unit 60 is formed to have the depth D1 larger than the maximum outer diameter of the leader pin 60 in this way, formation of a projecting portion protruding radially inward on the inner peripheral surface 220a of the reel hub 220 is avoided. For this reason, even in the case where the reel drive shaft (illustration omitted) of the drive apparatus is configured to be inserted into the reel hub 220, it is possible to prevent interference between the reel drive shaft and the leader pin 50.

The housing unit 60 further includes a slit-shaped passage portion 602 that communicates between the recessed groove portion 601 and the outer peripheral surface 220b of the reel hub 220, the magnetic tape 1 being capable of passing through the passage portion 602. The passage portion 602 is formed at the bottom portion of the recessed groove portion 601 to have an opening width narrower than the recessed groove portion 601. The passage portion 602 faces the slit portion 222s of the upper flange 222 in the axial direction of the reel hub 220 and is formed to be capable of housing the magnetic tape 1 passing through the slit portion 222s. As a result, it is possible to attach the leader pin 50 attached to the tip portion of the magnetic tape 1 to the housing unit 60 via the central hole 222a of the upper flange 222.

As shown in FIG. 7, the reel hub 220 further includes a curved surface portion E10 formed at the boundary between the passage portion 602 of the housing unit 60 and the outer peripheral surface 220b of the reel hub 220. The curved surface portion E10 corresponds to a chamfered portion that is formed at the opening edge portions of the passage portions 602 facing each other in the circumferential direction of the reel hub 220 with the magnetic tape 1 sandwiched therebetween and is for suppressing, when winding the magnetic tape 1 pulled out radially outward from the passage portion 602 around the outer peripheral surface 220b of the reel hub 220, the damage to the magnetic tape 1 due to contact with the opening edge portions. In order to achieve such an object, it is favorable that the radius of curvature of the circular arc forming the curved surface portion E10 is 0.1 mm or more.

Further, in order to reduce tape damage due to winding pressure on the magnetic tape 1, the outer peripheral surface 220b of the reel hub 220 is favorably a smooth cylindrical surface. For example, the surface roughness of the outer peripheral surface 220b of the reel hub 220 is favorably 12 μm or less in Rz (maximum height) and 2 μm or less in Ra (arithmetic average roughness). Note that similarly, the surface roughness of the outer peripheral surface of the reel hub of the first tape reel 21 is favorably 12 μm or less in Rz and 2 μm or less in Ra.

As shown in FIG. 8, the leader pin 50 has a length greater than the thickness dimension of the second tape reel 22 along the axial direction, and the enlarged diameter portions 51e at both ends of the leader pin 50 protrude outward than the lower flange 221 and the upper flange 222 in the axial direction. In order to position the leader pin 50 with respect to the reel hub 220 in the axial direction, the housing unit 60 includes a pair of engaging portions 603 and 604 capable of engaging with the enlarged diameter portions 51e at both ends of the leader pin 50 in the axial direction of the reel hub 220.

Of the pair of engaging portions 603 and 604, one engaging portion 603 is formed by a protruding portion protruding toward the leader pin 50 on the side of the lower flange 221 of the recessed groove portion 601 and engages with an annular recessed portion 50c between the enlarged diameter portion 51e of the leader pin 50 on the lower end side and the lower end portion of the clamp member 52. Further, the other engaging portion 604 is formed by a protruding portion protruding from the opening 222b of the upper flange 222 toward the leader pin 50 and engages with the annular recessed portion 50c between the enlarged diameter portion 51e of the leader pin 50 on the upper end side and the upper end portion of the clamp member 52. As a result, it is possible to prevent positional deviation of the leader pin 50 in the axial direction with respect to the reel hub 220.

Further, as shown in FIG. 8, the inner surface of the lower flange 221 and the inner surface of the upper flange 222 are formed by inclined surfaces that are inclined in a direction in which the distance between the inner surfaces gradually increases radially outward of the second tape reel 22. As a result, it is possible to prevent the magnetic tape 1 and the flanges 221 and 222 from being in contact with each other during travelling of the magnetic tape 1 to avoid the edge damage of the magnetic tape 1. The inclination gradient of each of the inner surfaces of the lower flange 221 and the lower flange 222 is favorably 2 μm/mm or more. Note that the inner surfaces of the flanges 211 and 212 of the first tape reel 21 may also be formed in the same manner as described above.

In the tape cartridge 100 according to this embodiment configured as described above, since the housing unit 60 for housing the leader pin 50 is provided on the inner peripheral surface 220a of the reel hub 220 of the second tape reel 22, it is possible to reduce the step formed on the outer peripheral surface 220b of the reel hub 220 to a size equal to or less than the thickness of the magnetic tape 1. As a result, the step formed on the outer peripheral surface 220b of the reel hub 220 can be made smaller as much as possible, and thus, it is possible to suppress the deformation of the magnetic tape 1 during winding of the magnetic tape 1 around the reel hub 220. Therefore, it is possible to deal with thinning of the magnetic tape 1 and prevent adverse effects on the magnetic layer 43 of the magnetic tape 1.

Further, in accordance with this embodiment, the magnetic tape 1 can be fixed to the reel hub 220 of the second tape reel 22 simply by housing the leader pin 50 in the housing unit 60 of the second tape reel 22. For this reason, it is possible to easily attach the magnetic tape 1 to the second tape reel 22.

Further, in accordance with this embodiment, even if a malfunction occurs in the tape end detection operation on the drive apparatus side during winding of the magnetic tape 1 from the second tape reel 22 to the first tape reel 21, it is possible to prevent the magnetic tape 1 from slipping off the second tape reel 22 by the action of the housing unit 60 holding the leader pin 50.

[Method of Producing Tape Cartridge]

Next, a method of producing (method of assembling) the tape cartridge 100 according to this embodiment will be described.

First, the magnetic tape 1 having a predetermined length is wound around the reel hub 210 of the first tape reel 21. Subsequently, the leader pin 50 is attached to the tip portion of the magnetic tape 1 (see FIG. 2). Then, the leader pin 50 is attached to the second tape reel 22.

When the leader pin 50 is attached to the second tape reel 22, the magnetic tape 1 is inserted through the slit portion 222s of the upper flange 222 and the passage portion 602 of the reel hub 220 while a certain amount of tension is applied to the magnetic tape 1 to linearly pull out the magnetic tape 1. As a result, the leader pin 50 is disposed inside the reel hub 220 via the central hole 222a of the upper flange 222 and the magnetic tape 1 is disposed between the upper flange 222 and the lower flange 221 (see FIGS. 5 and 6).

Subsequently, by pulling the magnetic tape 1 radially outward of the second tape reel 22, the leader pin 50 is housed in the housing unit 60 of the inner peripheral surface 220a of the reel hub 220. At this time, the upper and lower annular recessed portions 50c of the leader pin 50 are caused to engage with the pair of engaging portions 603 and 604 (see FIG. 8). After that, the magnetic tape 1 is wound around the outer peripheral surface of the reel hub 220 by a predetermined length.

Subsequently, the first tape reel 21 and the second tape reel 22 are housed in the cartridge case 10 together with the magnetic tape 1.

In this way, the tape cartridge 100 is assembled.

### Second Embodiment

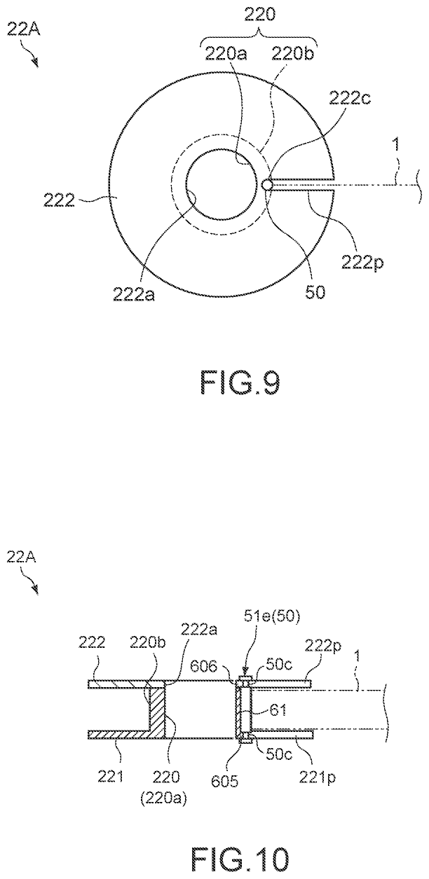

Subsequently, a second embodiment of the present technology will be described. FIG. 9 is a plan view of a second tape reel 22A according to this embodiment, and FIG. 10 is a cross-sectional side view of FIG. 9.

In this embodiment, the configuration of the second tape reel 22A is different from that in the above-mentioned first embodiment. Hereinafter, configurations different from those in the first embodiment will be mainly described, and configurations similar to those in the first embodiment will be denoted by similar reference symbols, and description thereof will be omitted or simplified.

Similarly to the first embodiment, the second tape reel 22A according to this embodiment the cylindrical reel hub 220, the disk-shaped lower flange 221 (first flange) provided to one end portion (lower end portion) of the reel hub 220, and the disk-shaped upper flange 222 (second flange) provided to the other end portion (upper end portion) of the reel hub 220.

The reel hub 220 has the inner peripheral surface 220a and the outer peripheral surface 220b, and a housing unit 61 capable of housing the leader pin 50 is provided on the outer peripheral surface 220b. The housing unit 61 positions the leader pin 50 attached to the tip of the magnetic tape 1 to the reel hub 220 and allows the magnetic tape 1 to be wound around the outer peripheral surface 220b of the reel hub 220 by rotation of the second tape reel 22A.

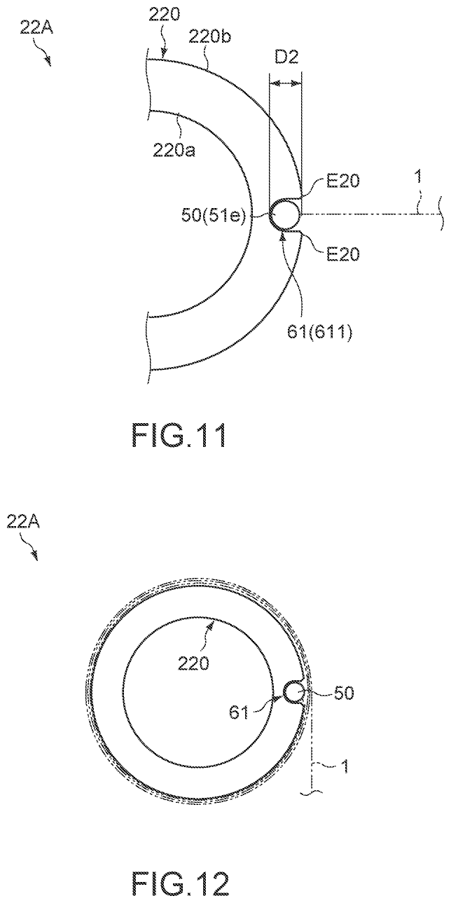

FIG. 11 is an enlarged plan view of a main part of the reel hub 220 showing details of the housing unit 60, and FIG. 12 is a plan view of the reel hub 220 showing how the magnetic tape 1 is wound.

As shown in FIG. 11, the housing unit 61 includes a partially cylindrical recessed groove portion 611 that supports the leader pin 50, which is formed along the axial direction of the reel hub 220 on the outer peripheral surface 220b of the reel hub 220. The recessed groove portion 611 houses the clamp member 52 of the leader pin 50 and positions the leader pin 50 in the circumferential direction of the reel hub 220.

The housing unit 61 is formed to have a depth D2 larger than the maximum outer diameter of the leader pin 50. The maximum outer diameter of the leader pin 50 corresponds to the outer diameter of the enlarged diameter portions 51e provided at both end portions of the shaft portion 51. Since the housing unit 61 is formed to have the depth D2 larger than the maximum outer diameter of the leader pin 60 in this way, formation of a projecting portion protruding radially outward on the outer peripheral surface 220b of the reel hub 220 is avoided. For this reason, the step formed on the outer peripheral surface 220b of the reel hub 220 can be made smaller as much as possible, and thus, it is possible to suppress the deformation of the magnetic tape 1 during winding of the magnetic tape 1 as shown in FIG. 12.

As shown in FIG. 11, the reel hub 220 further includes a curved surface portion E20 formed at the boundary between the housing unit 61 and the outer peripheral surface 220b of the reel hub 220. The curved surface portion E20 corresponds to a chamfered portion that is formed at the opening edge portions of the housing units 61 (recessed groove portions 611) facing each other in the circumferential direction of the reel hub 220 with the magnetic tape 1 sandwiched therebetween and is for suppressing, when winding the magnetic tape 1 pulled out radially outward from the housing unit 61 around the outer peripheral surface 220b of the reel hub 220, the damage to the magnetic tape 1 due to contact with the opening edge portions. In order to achieve such an object, it is favorable that the radius of curvature of the circular arc forming the curved surface portion E20 is 0.1 mm or more.

Further, in order to reduce tape damage due to winding pressure on the magnetic tape 1, the outer peripheral surface 220b of the reel hub 220 is favorably a smooth cylindrical surface. For example, the surface roughness of the outer peripheral surface 220b of the reel hub 220 is favorably 12 μm or less in Rz (maximum height) and 2 μm or less in Ra (arithmetic average roughness). Note that similarly, the surface roughness of the outer peripheral surface of the reel hub of the first tape reel 21 is favorably 12 μm or less in Rz and 2 μm or less in Ra.

The upper flange 222 includes the central hole 222a concentric with the reel hub 220 and a slit portion 222p through which the magnetic tape 1 and the leader pin 50 are capable of passing. The slit portion 222p is formed to have a width equal to or larger than the outer diameter of the leader pin 50. The slit portion 222p is linearly formed in the radial direction from the position of the outer peripheral surface 220b of the reel hub 220 facing the housing unit 61 to the outer peripheral edge portion of the upper flange 222.

Similarly, the lower flange 221 also includes a slit portion 221p through which the magnetic tape 1 and the leader pin 50 are capable of passing. The slit portion 221p is formed to have a width equal to or larger than the outer diameter of the leader pin 50. The slit portion 221p is linearly formed in the radial direction from the position of the outer peripheral surface 220b of the reel hub 220 facing the housing unit 61 to the outer peripheral edge portion of the lower flange 221. The slit portion 221p of the lower flange 221 and the slit portion 222p of the upper flange 222 are disposed to face each other in the axial direction of the reel hub 220.

As shown in FIG. 10, the leader pin 50 has a length greater than the thickness dimension of the second tape reel 22A along the axial direction, and the enlarged diameter portions 51e at both ends of the leader pin 50 protrude outward than the lower flange 221 and the upper flange 222 in the axial direction. In order to position the leader pin 50 with respect to the reel hub 220 in the axial direction, the housing unit 61 includes a pair of engaging portions 605 and 606 capable of engaging with the enlarged diameter portions 51e at both ends of the leader pin 50 in the axial direction of the reel hub 220.

Of the pair of engaging portions 605 and 606, one engaging portion 605 is formed by a protruding portion protruding toward the leader pin 50 on the side of the lower flange 221 of the housing unit 61 and engages with the annular recessed portion 50c between the enlarged diameter portion 51e of the leader pin 50 on the side of the lower end and the lower end portion of the clamp member 52. Further, the other engaging portion 606 is formed between the central hole 222a and the slit portion 222p of the upper flange 222 and engages with the annular recessed portion 50c between the enlarged diameter portion 51e of the leader pin 50 on the upper end side and the upper end portion of the clamp member 52. As a result, it is possible to prevent positional deviation of the leader pin 50 in the axial direction with respect to the reel hub 220.

Note that also in this embodiment, the inner surface of the lower flange 221 and the inner surface of the upper flange 222 are formed by inclined surfaces that are inclined in a direction in which the distance between the inner surfaces gradually increases radially outward of the second tape reel 22A, similarly to the first embodiment. As a result, it is possible to prevent the magnetic tape 1 and the flanges 221 and 222 from being in contact with each other during travelling of the magnetic tape 1 to avoid the edge damage of the magnetic tape 1. The inclination gradient of each of the inner surfaces of the lower flange 221 and the lower flange 222 is favorably 2 μm/mm or more.

Also in this embodiment, it is possible to achieve the operation and effect similar to those in the first embodiment. In accordance with this embodiment, since the housing unit 61 for housing the leader pin 50 is provided on the outer peripheral surface 220b of the reel hub 220 of the second tape reel 22A, it is possible to reduce the step formed on the outer peripheral surface 220b of the reel hub 220 to a size equal to or less than the thickness of the magnetic tape 1. As a result, the step formed on the outer peripheral surface 220b of the reel hub 220 can be made smaller as much as possible, and thus, it is possible to suppress the deformation of the magnetic tape 1 during winding of the magnetic tape 1 around the reel hub 220. As a result, it is possible to deal with thinning of the magnetic tape 1 and prevent adverse effects on the magnetic layer 43 of the magnetic tape 1.

Further, in accordance with this embodiment, it is possible to fix the magnetic tape 1 to the reel hub 220 of the second tape reel 22A simply by housing the leader pin 50 in the housing unit 61 of the second tape reel 22A. For this reason, it is possible to easily attach the magnetic tape 1 to the second tape reel 22A.

When attaching the leader pin 50 to the second tape reel 22A, the leader pin 50 is attached to the housing unit 61 of the outer periphery portion 220b of the reel hub 220 through the slit portions 221p and 222p formed in the lower flange 221 and the upper flange 222 of the second tape reel 22A. As a result, the leader pin 50 and the magnetic tape 1 are disposed between the upper flange 222 and the lower flange 221. At this time, the upper and lower annular recessed portions 50c of the leader pin 50 are caused to engage with the pair of engaging portions 605 and 606 (see FIGS. 9 and 10).

Subsequently, the magnetic tape 1 is wound around the outer peripheral surface of the reel hub 220 by a predetermined length (see FIG. 12). After that, the first tape reel 21 and the second tape reel 22A are housed in the cartridge case 10 together with the magnetic tape 1.

Note that the leader pin 50 may be attached to the housing unit 61 of the reel hub 220 through only one slit portion (e.g., the slit portion 221p) of the slit portions 221p and 222p formed in the lower flange 221 and the upper flange 222. In this case, formation of the other slit portion (e.g., the slit portion 222p) may be omitted.

### Third Embodiment

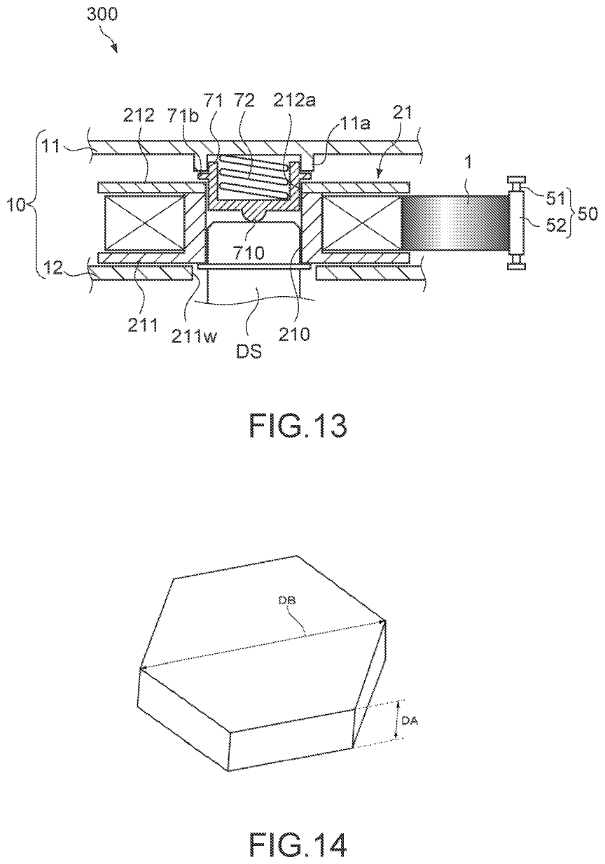

Next, a third embodiment of the present technology will be described. FIG. 13 is a cross-sectional side view of a main part of a tape cartridge 300 according to this embodiment.

Hereinafter, configurations different from those in the first embodiment will be mainly described, and configurations similar to those in the first embodiment will be denoted by similar reference symbols, and description thereof will be omitted or simplified.

The tape cartridge 300 according to this embodiment is different from the above-mentioned first embodiment in that it includes a support member 71 that presses a reel drive shaft DS of the drive apparatus causing the first tape reel 21 to rotate.

As shown in FIG. 13, in the lower shell 12 of the cartridge case 10, a circular insertion hole 211w for inserting the reel drive shaft DS into the reel hub 210 is formed immediately below the first tape reel 21. An engagement claw that engages with the reel drive shaft DS is provided to the inner peripheral surface of the reel hub 210.

Note that although not shown, in the lower shell 12, a circular insertion hole for inserting the reel drive shaft into the reel hub 220 is also formed immediately below the second tape reel 22. Although the first tape reel 21 will be mainly described in the following description, it may be similarly applied also to the second tape reel 22.

The support member 71 is disposed inside the reel hub 210 and abuts on the tip portion of the reel drive shaft DS inserted through the reel hub 210. The support member 71 is a cylindrical member having an outer diameter smaller than the inner diameter of the reel hub 210, and part thereof is disposed inside a central hole 212a of an upper flange 211 and the reel hub 210. A hemispherical abutting portion 71a abutting on the tip portion of the reel drive shaft DS is provided to the bottom surface portion of the support member 71. As a result, it is possible to make the pressing area on the reel drive shaft DS constant to make the pressing force constant.

The tape cartridge 300 further includes an elastic member 72 disposed between the support member 71 and the upper shell 11. The elastic member 72 is a coil spring and presses the support member 71 toward the tip portion of the reel drive shaft DS. The inner surface of the upper shell 11 includes a guide unit 11a that houses one end (upper end) of the elastic member 72 and supports the support member 71 so as to be movable in the axial direction of the reel hub 210. The guide unit 11a is an annular protruding portion that is formed on the inner surface of the upper shell 11 and has an inner diameter larger than the outer shape of the support member 71.

Note that a stopper portion 71b located between the first tape reel 21 (upper flange 212) and the guide unit 11a is provided on the circumferential surface of the support member 71. The stopper portion 71b is a protruding portion formed on the circumferential surface of a support surface 71 and receives the biasing force of the elastic member 72 to abut on the peripheral edge portion of the central hole 212a of the upper flange 212 when the cartridge is not in use where the reel drive shaft DS is not inserted through the insertion hole 211w.

In the tape cartridge 300 according to this embodiment configured as described above, when the reel drive shaft DS is inserted through the first tape reel 21 via the insertion hole 211w, the support member 71 is lifted toward the upper shell 11 by abutting on the reel drive shaft DS, and the stopper portion 71b and the upper flange 212 are brought into a non-contact state. The reel drive shaft DS relatively rotates around the axis relative to the support member 71 to cause the first tape reel 21 to rotate. As a result, the magnetic tape 1 is wound from the first tape reel 21 to the second tape reel 22 or from the second tape reel 22 to the first tape reel 21.

In accordance with this embodiment, since the support member 71 for pressing the tip portion of the reel drive shaft DS in the axial direction is provided, the integration between the tape cartridge 300 and the reel drive shaft DS is enhanced and it is possible to stably transmit the driving force of the reel drive shaft to the first tape reel 21. Further, when pulling out the magnetic tape 1 from the first tape reel 21, the vibration of the reel drive shaft DS due to the tension of the magnetic tape 1 can be suppressed, and thus, it is possible to cause the magnetic tape 1 to stably travel.

[Details of Magnetic Tape]

Next, details of the magnetic tape 1 used in this embodiment will be described.

Note that in the following description, in the case where there is no particular mention of the measurement environment in the explanation of the measurement method, the measurement is performed under the environment of 25° C.±2° C. and 50% RH±5% RH.

As shown in FIG. 4, the magnetic tape 1 is formed in a tape shape that is long in the longitudinal direction (X-axis direction), short in the width direction (Y-axis direction), and thin in the thickness direction (Z-axis direction).

The magnetic tape 1 includes the tape-shaped base material 41 that is long in the longitudinal direction (X-axis direction), the underlayer (non-magnetic layer) 42 provided on one main surface of the base material 41, the magnetic layer 43 provided on the underlayer 42, and the back layer 44 provided on the other main surface of the base material 41. Note that the back layer 44 only needs to be provided as required and this back layer 44 may be omitted. The magnetic tape 1 may be a magnetic recording medium of a perpendicular recording type or a magnetic recording medium of a longitudinal recording type.

The magnetic tape 1 has a long tape shape and is caused to travel in the longitudinal direction during recording and reproduction. Note that the surface of the magnetic layer 43 is a surface on which a magnetic head included in a recording/reproduction apparatus (not shown) is caused to travel. The magnetic tape 1 is favorably used in a recording/reproduction apparatus including a ring-type head as a recording head. The magnetic tape 1 is favorably used in a recording/reproduction apparatus configured to be capable of recording data with a data track width of 1500 nm or less or 1000 nm or less.

(Base Material)

The base material 41 is a non-magnetic support that supports the underlayer 42 and the magnetic layer 43. The base material 41 has a long film shape. The upper limit value of the average thickness of the base material 41 is favorably 4.2 μm or less, more favorably 3.8 μm or less, and still more favorably 3.4 μm. When the upper limit value of the average thickness of the base material 41 is 4.2 μm or less, it is possible to make the recording capacity of a single data cartridge larger than that of a general magnetic tape. The lower limit value of the average thickness of the base material 41 is favorably 3 μm or more, and more favorably 3.2 μm or more. When the lower limit value of the average thickness of the base material 41 is 3 μm or more, it is possible to suppress a decrease in the strength of the base material 41.

The average thickness of the base material 41 is obtained as follows. First, the magnetic tape 1 housed in the cartridge case 10 is unwound and the magnetic tape 1 is cut into a length of 250 mm at the position between 30 m or more and +10 m in the longitudinal direction from the connection portion between the magnetic tape 1 and the leader pin 50 to prepare a sample. In this specification, the “longitudinal direction” in the case of the “longitudinal direction from the connection portion between the magnetic tape 1 and the leader pin 50” means a direction from an end on the side of the leader pin 50 to the other end on the opposite side.

Subsequently, the layers of the sample other than the base material 41 (i.e., the underlayer 42, the magnetic layer 43, and the back layer 44) are removed with a solvent such as MEK (methyl ethyl ketone) and dilute hydrochloric acid. Next, a Laser Hologage (LGH-110C) manufactured by Mitutoyo Corporation is used as a measuring apparatus to measure the thickness of the sample (base material 41) at five positions, and the measured values are simply averaged (arithmetically averaged) to calculate the average thickness of the base material 41. Note that the five measurement positions described above are randomly selected from the sample such that they are different positions in the longitudinal direction of the magnetic tape 1.

The base material 41 contains, for example, polyester as a main component. The polyester may be, for example, one or a mixture of two or more of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p(oxybenzoate), and polyethylene bisphenoxycarboxylate. In this specification, the “main component” means a component having the highest content ratio, of the components constituting the base material 41. For example, the fact that the main component of the base material 41 is polyester may mean that the content ratio of polyester in the base material 41 is, for example, 50 mass % or more, 60 mass % or more, 70 mass % or more, 80 mass % or more, 90 mass % or more, 95 mass % or more, or 98 mass % or more with respect to mass of the base material 41 or that the base material 41 is formed of only polyester.

In this embodiment, the base material 41 may contain, in addition to polyester, a resin described below other than polyester.

In accordance with a favorable embodiment of the present technology, the base material 41 may be formed of PET or PEN.

The fact that the base material 41 contains polyester can be confirmed, for example, as follows. First, the magnetic tape 1 is prepared and cut into a length of 250 mm to prepare a sample and then the layers of the sample other than the base material 41 are removed in a way similar to that in the measurement method of the average thickness of the base material 41. Next, the IR spectrum of the sample (base material 41) is acquired using the infrared absorption spectrometry (IR). On the basis of this IR spectrum, the fact that the base material 41 contains polyester can be confirmed.

The base material 41 favorably contains polyester. When the base material 41 contains polyester, the Young's modulus of the base material 41 in the longitudinal direction can be reduced to favorably 2.5 GPa or more and 7.8 GPa or less, and more favorably 3.0 GPa or more and 7.0 GPa or less. Therefore, it is possible to keep the width of the magnetic tape 1 constant or substantially constant by adjusting the tension of the magnetic tape 1 in the longitudinal direction during travelling by the recording/reproduction apparatus. The measurement method of the Young's modulus of the base material 41 in the longitudinal direction will be described below.

Another embodiment of the present technology, the base material 41 may be formed of a resin other than polyester. The resin forming the base material 41 can include, for example, at least one of a polyolefin resin, a cellulose derivative, a vinyl resin, and a different polymer resin. In the case where the base material 41 contains two or more of these resins, the two or more materials may be mixed, may be copolymerized, or may be stacked.

The polyolefin resin includes, for example, at least one of PE (polyethylene) or PP (polypropylene). The cellulose derivative includes, for example, at least one of cellulose diacetate, cellulose triacetate, CAB (cellulose acetate butyrate), or CAP (cellulose acetate propionate). The vinyl resin includes, for example, at least one of PVC (polyvinyl chloride) or PVDC (polyvinylidene chloride).

The different polymer resin includes, for example, at least one of PEEK (polyetheretherketone), PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, e.g., Zylon (registered trademark)), polyether, PEK (polyetherketone), polyetherester, PES (polyethersulfone), PEI (polyetherimide), PSF (polysulfone), PPS (polyphenylene sulfide), PC (polycarbonate), PAR (polyarylate), or PU (polyurethane).

The base material 41 may be biaxially stretched in the longitudinal direction and the width direction. The polymer resin contained in the base material 41 is favorably oriented in an oblique direction with respect to the width direction of the base material 41.

(Magnetic Layer)

The magnetic layer 43 is a recording layer for recording a signal with a magnetization pattern. The magnetic layer 43 may be a recording layer of a perpendicular recording type or may be a recording layer of a longitudinal recording type. The magnetic layer 43 contains, for example, magnetic powder, a binder, and a lubricant. The magnetic layer 43 may further contain at least one additive of an antistatic agent, an abrasive, a curing agent, a rust inhibitor, a non-magnetic reinforcing particle, or the like, as necessary. The magnetic layer 43 does not necessarily need to include a coating film of a magnetic material and may include a sputtering film or a deposition film of a magnetic film.

An arithmetic average roughness Ra of the surface of the magnetic layer 43 is 2.0 nm or less, favorably 1.8 nm or less, and more favorably 1.6 nm or less. When the arithmetic average roughness Ra is 2.0 nm or less, since the output reduction due to spacing loss can be suppressed, excellent electromagnetic conversion characteristics can be achieved. The lower limit value of the arithmetic average roughness Ra of the surface of the magnetic layer 43 is favorably 1.0 nm or more, and more favorably 1.2 nm or more. When the lower limit value of the arithmetic average roughness Ra of the surface of the magnetic layer 43 is 1.0 nm or more, it is possible to suppress deterioration of the traveling property due to an increase in friction.

The arithmetic average roughness Ra can be obtained as follows. First, the surface of the magnetic layer 43 is observed by an atomic force microscope (AFM) to obtain an AFM image of 40 μm×40 μm. Nano Scope IIIa D3100 manufactured by Digital Instruments is used as the AFM, one formed of silicon single crystal is used as a cantilever (Note 1), and measurement is performed by turning at 200 to 400 Hz as the tapping frequency. Next, the AFM image is divided into 512×512 (=262,144) measurement points, a height Z(i) (i: measurement point numbers, i=1 to 262,144) is measured at each measurement point, and the heights Z(i) at the respective measurement points are simply averaged (arithmetically averaged) to obtain an average height (average surface) Zave (=(Z(1)+Z(2)+ . . . +Z(262,144))/262,144). Subsequently, a deviation Z″(i) from an average center line at each measurement point (=Z(i)−Zave) is obtained to calculate the arithmetic average roughness Ra [nm] (=(Z″(1)+Z″(2)+ . . . +Z″(262,144))/262,144). At this time, one that has been subjected to filtering by second-order Flatten and third-order planefit in XY as image processing is used as data.

(Note 1) SPM probe NCH of a normal type, POINTPROBE manufactured by NanoWorld

L (Cantilever Length)=125 μm

The upper limit value of an average thickness tₘ of the magnetic layer 43 is 80 nm or less, favorably 70 nm or less, and more favorably 50 nm or less. When the upper limit value of the average thickness tₘ of the magnetic layer 43 is 80 nm or less, the influence of the demagnetizing field can be reduced in the case where a ring-type head is used as the recording head, and thus, more excellent electromagnetic conversion characteristics can be achieved.

The lower limit value of the average thickness tₘ of the magnetic layer 43 is favorably 35 nm or more. When the lower limit value of the average thickness tₘ of the magnetic layer 43 is 35 nm or more, the output can be ensured in the case where an MR-type head is used as the reproduction head, and thus, more excellent electromagnetic conversion characteristics can be achieved.

The average thickness t₁ of the magnetic layer 43 is obtained as follows. First, the magnetic tape 1 housed in the cartridge case 10 is unwound and the magnetic tape 1 is cut into a length of 250 mm at three positions between 10 m, 30 m, and 50 m and +10 m in the longitudinal direction from the connection portion between the magnetic tape 1 and the leader pin 50 to prepare three samples. Subsequently, each sample is processed by an FIB method or the like to obtain a slice. In the case of using an FIB method, a carbon layer and a tungsten layer are formed as protective films as pre-processing for observing a TEM image of a cross section described below. The carbon layer is formed on each of the surfaces of the magnetic tape 1 on the side of the magnetic layer 43 and on the side of the back layer 44 by a vapor deposition method and the tungsten layer is further formed on the surface on the side of the magnetic layer 43 by a vapor deposition method or a sputtering method. The slicing is performed along the longitudinal direction of the magnetic tape 1. That is, the slicing forms a cross section parallel to both the longitudinal direction and the thickness direction of the magnetic tape 1.

The cross section described above of the obtained sliced sample is observed through a transmissionelectron microscope (TEM) under the following conditions to obtain a TEM image. Note that the magnification and the acceleration voltage may be adjusted as appropriate in accordance with the type of apparatus.
Apparatus: TEM (H9000NAR manufactured by Hitachi, Ltd.)
Acceleration voltage: 300 kV
Magnification: 100,000 times

Next, the thickness of the magnetic layer 43 is measured at at least ten or more positions of the magnetic tape 1 in the longitudinal direction using the obtained TEM image. Note that the 10 or more measurement positions of each sliced sample are randomly selected from the sample such that they are different positions in the longitudinal direction of the magnetic tape 1. The average value obtained by simply averaging (arithmetically averaging) the obtained measured values is used as the average thickness tₘ [nm] of the magnetic layer 43. Note that the position where the measurement described above is performed is randomly selected from the test piece.

(Magnetic Powder)

The magnetic powder includes a plurality of magnetic particles. The magnetic particles are, for example, particles including hexagonal ferrite (hereinafter, referred to as “hexagonal ferrite particles”), particles including epsilon-iron oxide (s-iron oxide) (hereinafter, referred to as “ε-iron oxide particles”), or particles including Co-containing spinel ferrite (hereinafter, referred to as “cobalt ferrite particles”). The magnetic powder is favorably crystal-oriented preferentially in the thickness direction of the magnetic tape 1 (perpendicular direction).

(Hexagonal Ferrite Particles)

Each of the hexagonal ferrite particles has a plate shape such as a hexagonal plate shape. In this specification, the hexagonal plate shape includes a substantially hexagonal plate shape. The hexagonal ferrite contains favorably at least one of Ba, Sr, Pb, or Ca, and more favorably at least one of Ba or Sr. The hexagonal ferrite may specifically be barium ferrite or strontium ferrite, for example. The barium ferrite may further contain at least one of Sr, Pb, or Ca in addition to Ba. The strontium ferrite may further contain at least one of Ba, Pb, or Ca in addition to Sr.

More specifically, the hexagonal ferrite has an average composition represented by a general formula of MFe₁₂O₁₉. However, M is, for example, at least one metal of Ba, Sr, Pb, or Ca, and favorably at least one metal of Ba or Sr. M may be a combination of Ba and one or more metals selected from the group consisting of Sr, Pb, and Ca. Further, M may be a combination of Sr and one or more metals selected from the group consisting of Ba, Pb, and Ca. In the general formula described above, some Fes may be substituted by another metal element.

In the case where the magnetic powder includes powder of the hexagonal ferrite particles, the average particle size of the magnetic powder is more favorably 12 nm or more and 25 nm or less, still more favorably 12 nm or more and 22 nm or less, particularly favorably 12 nm or more and 19 nm or less, and most favorably 12 nm or more and 16 nm or less. When the average particle size of the magnetic powder is 30 nm or less, more excellent electromagnetic conversion characteristics (e.g., SNR) can be achieved in the magnetic tape 1 having high recording density. Meanwhile, when the average particle size of the magnetic powder is 12 nm or more, the dispersibility of the magnetic powder is further improved and further excellent electromagnetic conversion characteristics (e.g., SNR) can be achieved.

The average aspect ratio of the magnetic powder is favorably 1.0 or more and 3.0 or less, more favorably 1.3 or more and 2.8 or less, and still more favorably 1.6 or more and 2.7 or less. When the average aspect ratio of the magnetic powder is within a range of 1.0 or more and 2.5 or less, agglomeration of the magnetic powder can be suppressed. Further, the resistance applied to the magnetic powder when perpendicularly orienting the magnetic powder in the process of forming the magnetic layer 43 can be suppressed. Therefore, it is possible to improve the perpendicular orientation property of the magnetic powder.

In the case where the magnetic powder includes powder of the hexagonal ferrite particles, the average particle size and the average aspect ratio of the magnetic powder are obtained as follows. First, the magnetic tape 1 housed in the cartridge case 10 is unwound and the magnetic tape 1 is cut out at the position between 30 m or more and +10 m in the longitudinal direction from the connection portion between the magnetic tape 1 and the leader pin 50. Subsequently, the magnetic tape 1 to be measured is processed by an FIB method or the like to obtain a slice. In the case of using an FIB method, a carbon layer and a tungsten layer are formed as protective films as pre-processing for observing a TEM image of a cross section described below. The carbon layer is formed on each of the surfaces of the magnetic tape 1 on the side of the magnetic layer 43 and on the side of the back layer 44 by a vapor deposition method and the tungsten layer is further formed on the surface on the side of the magnetic layer 43 by a vapor deposition method or a sputtering method. The slicing is performed along a length direction (longitudinal direction) of the magnetic tape 1. That is, the slicing forms a cross section parallel to both the longitudinal direction and the thickness direction of the magnetic tape 1.

A transmission electron microscope (H-9500 manufactured by Hitachi High-Technologies Corporation) is used for observing the cross section described above of the obtained slice sample such that the entire magnetic layer 43 is included with respect to the thickness direction of the magnetic layer 43 at the acceleration voltage: 200 kV and the total magnification: 500,000 times to take a TEM photograph. The number of TEM photographs to be prepared is the number that 50 particles for which a plate diameter DB and a plate thickness DA (see FIG. 14) shown below can be measured can be extracted.

In this specification, regarding the size of the hexagonal ferrite particles (hereinafter, referred to as a “particle size”.), in the case where the shape of the particle observed in the TEM photograph described above is a plate shape or a columnar shape (where the thickness or height is smaller than the major axis of the plate surface or bottom surface.) as shown in FIG. 14, the major axis of the plate surface or bottom surface is used as the value of the plate diameter DB. The thickness or height of the particle observed in the TEM photograph described above is used as the value of the plate thickness DA. In the case where the plate surface or bottom surface of the particle observed in the TEM photograph has a hexagonal shape, the major axis means the longest diagonal distance. In the case where the thickness or height of the particle is not constant in one particle, the maximum thickness or height of the particle is used as the plate thickness DA.

Next, 50 particles to be extracted from the taken TEM photograph are selected on the basis of the following criteria. Particles partially protruding outside the field of view of the TEM photograph are not measured, and particles with clear contours and present in isolation are measured. In the case where particles overlap, each of particles is measured as a single particle if the boundary between the particles is clear and the shape of the entire particle can be determined. However, particles whose boundaries are unclear and whose overall shape cannot be determined are not measured because the shape of the particle cannot be determined.

The maximum plate thickness DA of each of the selected 50 particles is measured. The maximum plate thicknesses DA obtained in this way are simply averaged (arithmetically averaged) to obtain an average maximum plate thickness DAₐᵥₑ. Subsequently, a plate diameter DB of each magnetic powder is measured. In order to measure the plate diameter DB of the particle, 50 particles whose plate diameter can be clearly checked are selected from the taken TEM photograph. The plate diameter DB of each of the selected 50 particles is measured. The plate diameters DB obtained in this way are simply averaged (arithmetically averaged) to obtain an average plate diameter DBₐᵥₑ. The average plate diameter DBₐᵥₑ is the average particle size. Then, an average aspect ratio (DBₐᵥₑ/DAₐᵥₑ) of the particles is obtained on the basis of the average maximum plate thickness DAₐᵥₑ and the average plate diameter DBₐᵥₑ.

In the case where the magnetic powder includes powder of the hexagonal ferrite particles, the average particle volume of the magnetic powder is favorably 500 nm³ or more and 2500 nm³ or less, more favorably 500 nm³ or more and 1600 nm³ or less, still more favorably 500 nm³ or more and 1500 nm³ or less, particularly favorably 600 nm³ or more and 1200 nm³ or less, and most favorably 600 nm³ or more and 1000 nm³ or less. When the average particle volume of the magnetic powder is 2500 nm³ or less, an effect similar to that in the case where the average particle size of the magnetic powder is 22 nm or less can be achieved. Meanwhile, when the average particle volume of the magnetic powder is 500 nm³ or more, an effect similar to that in the case where the average particle size of the magnetic powder is 13 nm or more can be achieved.

The average particle volume of the magnetic powder is obtained as follows. First, as described above with respect to the method of calculating the average particle size of the magnetic powder, the average major axis length DAₐᵥₑ and the average plate diameter DBₐᵥₑ are obtained. Next, an average volume V of the magnetic powder is obtained in accordance with the following formula.

$$V = \frac{3 \sqrt{3}}{8} \times {DA}_{ave} \times {DB}_{ave} \times {DB}_{ave} \qquad \{ Math . 1 \}$$

(ε-Iron Oxide Particles)

The ε-iron oxide particles are hard magnetic particles capable of achieving a high coercive force even as minute particles. The ε-iron oxide particles each have a spherical shape or a cubic shape. In this specification, the spherical shape includes a substantially spherical shape. Further, the cubic shape includes a substantially cubic shape. Since the ε-iron oxide particles have the shape as described above, it is possible to reduce the contact area of the particles in the thickness direction of the magnetic tape 1 and suppress agglomeration of the particles in the case where the ε-iron oxide particles are used as the magnetic particles, as compared with the case where barium ferrite particles having a hexagonal plate shape are used as the magnetic particles. Therefore, it is possible to enhance the dispersibility of the magnetic powder and achieve further excellent electromagnetic conversion characteristics (e.g., SNR).

Each of the ε-iron oxide particles has a core-shell structure. Specifically, the ε-iron oxide particle includes a core portion and a shell portion having a two-layer structure provided around the core portion. The shell portion having the two-layer structure includes a first shell portion provided on the core portion and a second shell portion provided on the first shell portion.

The core portion contains ε-iron oxide. The ε-iron oxide contained in the core portion is favorably one having ε—Fe₂O₃ crystals as the main phase, and more favorably one formed of single-phase ε—Fe₂O₃.

The first shell portion covers at least part of the periphery of the core portion. Specifically, the first shell portion may partially cover the periphery of the core portion or may entirely cover the periphery of the core portion. It is favorable that the first shell portion covers the entire surface of the core portion from the viewpoint of making the exchange coupling between the core portion and the first shell portion sufficient and improving the magnetic properties.

The first shell portion is a so-called soft magnetic layer and includes a soft magnetic material such as α-Fe, a Ni—Fe alloy, and an Fe—Si—Al alloy. The α-Fe may be obtained by reducing the ε-iron oxide contained in the core portion.

The second shell portion is an oxide film as an antioxidant layer. The second shell portion contains α-iron oxide, aluminum oxide, or silicon oxide. The α-iron oxide contains, for example, at least one iron oxide of Fe₃O₄, Fe₂O₃, or FeO. In the case where the first shell portion contains α-Fe (soft magnetic material), the α-iron oxide may be obtained by oxidizing α-Fe contained in the first shell portion.

Since the ε-iron oxide particle includes the first shell portion as described above, it is possible to adjust a coercive force Hc of the entire ε-iron oxide particles (core-shell particles) to the coercive force Hc suitable for recording while maintaining the coercive force Hc of the core portion alone at a large value for achieving thermal stability. Further, since the ε-iron oxide particle includes the second shell portion as described above, it is possible to adjust the coercive force and the magnetic flux density of the magnetic particles.

The ε-iron oxide particle may include a shell portion having a single-layer structure. In this case, the shell portion has a configuration similar to that of the first shell portion. However, from the viewpoint of suppressing deterioration of the properties of the ε-iron oxide particles, it is favorable that the ε-iron oxide particle includes the shell portion having a two-layer structure, as described above.

The ε-iron oxide particles may include an additive instead of the core-shell structure described above or may include an additive while having the core-shell structure. In this case, some Fes of the ε-iron oxide particles are substituted by the additive. Also with the ε-iron oxide particles including the additive, the coercive force Hc of the entire ε-iron oxide particles can be adjusted to the coercive force Hc suitable for recording, and thus, it is possible to improve the easiness of recording. The additive is a metal element other than iron, favorably a trivalent metal element, more favorably at least one of Al, Ga, or In, and sill more favorably at least one of Al or Ga.

Specifically, the ε-iron oxide including the additive is ε—Fe₂₋ₓMₓO₃ crystals (where M is a metal element other than iron, favorably a trivalent metal element, more favorably at least one of Al, Ga, or In, and still more favorably at least one of Al or Ga. x is, for example, 0<x<1.).

In the case where the magnetic powder includes the ε-iron oxide particles, the average particle size of the magnetic powder is favorably 10 nm or more and 20 nm or less, more favorably 10 nm or more and 18 nm or less, still more favorably 10 nm or more and 16 nm or less, particularly favorably 10 nm or more and 15 nm or less, and most favorably 10 nm or more and 14 nm or less. In the magnetic tape 1, a region having a size of ½ of the recording wavelength is an actual magnetized region. For this reason, by setting the average particle size of the magnetic powder to half or less of the shortest recording wavelength, it is possible to achieve more excellent electromagnetic conversion characteristics (e.g., SNR). Therefore, when the average particle size of the magnetic powder is 20 nm or less, it is possible to achieve more excellent electromagnetic conversion characteristics (e.g., SNR) in the magnetic tape 1 having high recording density (e.g., the magnetic tape 1 configured to be capable of recording a signal at the shortest recording wavelength of 40 nm or less). Meanwhile, when the average particle size of the magnetic powder is 10 nm or more, the dispersibility of the magnetic powder is further improved and it is possible to achieve more excellent electromagnetic conversion characteristics (e.g., SNR).

The average aspect ratio of the magnetic powder is favorably 1.0 or more and 3.0 or less, more favorably 1.0 or more and 2.5 or less, still more favorably 1.0 or more and 2.1 or less, and particularly favorably 1.0 or more and 1.8 or less. When the average aspect ratio of the magnetic powder is within a range of 1.0 or more and 3.0 or less, it is possible to suppress agglomeration of the magnetic powder. Further, the resistance applied to the magnetic powder when perpendicularly orienting the magnetic powder in the process of forming the magnetic layer 43 can be suppressed. Therefore, it is possible to improve the perpendicular orientation property of the magnetic powder.

In the case where the magnetic powder includes powder of the ε-iron oxide particles, the average particle size and the average aspect ratio of the magnetic powder are obtained as follows. First, the magnetic tape 1 housed in the cartridge case 10 is unwound and the magnetic tape 1 is cut out at the position between 30 m or more and +10 m in the longitudinal direction from the connection portion between the magnetic tape 1 and the leader pin 50. Subsequently, the magnetic tape 1 to be measured is processed by an FIB (Focused Ion Beam) method or the like to obtain a slice. In the case of using an FIB method, a carbon layer and a tungsten layer are formed as protective layers as pre-processing for observing a TEM image of a cross section described below. The carbon layer is formed on each of the surfaces of the magnetic tape 1 on the side of the magnetic layer 43 and on the side of the back layer 44 by a vapor deposition method and the tungsten layer is further formed on the surface on the side of the magnetic layer 43 by a vapor deposition method or a sputtering method. The slicing is performed along a length direction (longitudinal direction) of the magnetic tape 1. That is, the slicing forms a cross section parallel to both the longitudinal direction and the thickness direction of the magnetic tape 1.

A transmission electron microscope (H-9500 manufactured by Hitachi High-Technologies Corporation) is used for observing the cross section described above of the obtained slice sample such that the entire magnetic layer 43 is included with respect to the thickness direction of the magnetic layer 43 at the acceleration voltage: 200 kV and the total magnification: 500,000 times to take a TEM photograph. Next, 50 particles, which have the shape that can be clearly checked, are selected from the taken TEM photograph, and a long-axis length DL and a short-axis length DS of each particle are measured. Here, the long-axis length DL means the maximum one (so-called maximum Feret diameter) of distances between two parallel lines drawn at any angle so as to be in contact with the outline of each particle. Meanwhile, the short-axis length DS means the maximum one of particle lengths in a direction orthogonal to a long axis (DL) of the particle. Subsequently, the measured long-axis lengths DL of the 50 particles are simply averaged (arithmetically averaged) to obtain an average major axis length DLₐᵥₑ. The average major axis length DLₐᵥₑ obtained in this way is used as the average particle size of the magnetic powder. Further, the measured short-axis lengths DS of the 50 particles are simply averaged (arithmetically averaged) to obtain an average short-axis length DSₐᵥₑ. Then, an average aspect ratio (DLₐᵥₑ/DSₐᵥₑ) of the particles is obtained on the basis of the average major axis length DLₐᵥₑ and the average short-axis length DSₐᵥₑ.

In the case where the magnetic powder includes the ε-iron oxide particles, the average particle volume of the magnetic powder is favorably 500 nm³ or more and 4000 nm³ or less, more favorably 500 nm³ or more and 3000 nm³ or less, still more favorably 500 nm³ or more and 2000 nm³ or less, particularly favorably 600 nm³ or more and 1600 nm³ or less, and most favorably 600 nm³ or more and 1300 nm³ or less. Since noise of the magnetic tape 1 is generally inversely proportional to the square root of the number of particles (i.e., proportional to the square root of the particle volume), it is possible to achieve more excellent electromagnetic conversion characteristics (e.g., SNR) by making the particle volume smaller. Therefore, when the average particle volume of the magnetic powder is 4000 nm³ or less, it is possible to achieve more excellent electromagnetic conversion characteristics (e.g., SNR) as in the case where the average particle size of the magnetic powder is 20 nm or less. Meanwhile, when the particle volume of the magnetic powder is 500 nm³ or more, an effect similar to that in the case where the average particle size of the magnetic powder is 10 nm or more can be achieved.

In the case where the ε-iron oxide particles each have a spherical shape, the average particle volume of the magnetic powder is obtained as follows. First, the average major axis length DLₐᵥₑ is obtained in a way similar to the method of calculating the average particle size of the magnetic powder described above. Next, the average volume V of the magnetic powder is obtained in accordance with the following formula.

V=(π/6)×DLₐᵥₑ³

In the case where the ε-iron oxide particles each have a cubic shape, the average volume of the magnetic powder can be obtained as follows. First, the magnetic tape 1 housed in the cartridge case 10 is unwound and the magnetic tape 1 is cut out at the position between 30 m or more and +10 m in the longitudinal direction from the connection portion between the magnetic tape 1 and the leader pin 50. Subsequently, the cut magnetic tape 1 is processed by an FIB (Focused Ion Beam) method or the like to obtain a slice. In the case of using an FIB method, a carbon film and a tungsten thin film are formed as protective films as pre-processing for observing a TEM image of a cross section described below. The carbon film is formed on each of the surfaces of the magnetic tape 1 on the side of the magnetic layer 43 and on the side of the back layer 44 by a vapor deposition method and the tungsten thin film is further formed on the surface on the side of the magnetic layer 43 by a vapor deposition method or a sputtering method. The slicing is performed along a length direction (longitudinal direction) of the magnetic tape 1. That is, the slicing forms a cross section parallel to both the longitudinal direction and the thickness direction of the magnetic tape 1.

A transmission electron microscope (H-9500 manufactured by Hitachi High-Technologies Corporation) is used for observing the cross section of the obtained slice sample such that the entire magnetic layer 43 is included with respect to the thickness direction of the magnetic layer 43 at the acceleration voltage: 200 kV and the total magnification: 500,000 times to take a TEM photograph. Note that the magnification and the acceleration voltage may be adjusted as appropriate in accordance with the type of apparatus. Next, 50 particles, which have a clear shape, are selected from the taken TEM photograph, and a length DC of a side of each particle is measured. Subsequently, the measured lengths DC of the 50 particles are simply averaged (arithmetically averaged) to obtain an average side length DCₐᵥₑ. Next, an average volume Vₐᵥₑ (particle volume) of the magnetic powder is obtained on the basis of the following formula by using the average side length DCₐᵥₑ.

Vₐᵥₑ=DCₐᵥₑ³

(Cobalt Ferrite Particles)

It is favorable that the cobalt ferrite particles each have uniaxial crystal anisotropy. Since the cobalt ferrite particle has uniaxial crystal anisotropy, it is possible to make the magnetic powder preferentially crystal-oriented in the thickness direction (perpendicular direction) of the magnetic tape 1. The cobalt ferrite particle has, for example, a cubic shape. In this specification, the cubic shape includes a substantially cubic shape. The Co-containing spinel ferrite may further contain at least one of Ni, Mn, Al, Cu, or Zn in addition to Co.

The Co-containing spinel ferrite has an average composition represented by the following formula, for example.

CoₓM_{y}Fe₂O_{z}

(where M is, for example, at least one metal of Ni, Mn, Al, Cu, or Zn. x is a value in a range of 0.4≤x≤1.0. y is a value in a range of 0≤y≤0.3. However, x and y satisfy the relationship of (x+y)≤1.0. z is a value in a range of 3≤z≤4. Some Fes may be substituted by another metal element.)

In the case where the magnetic powder includes powder of the cobalt ferrite particles, the average particle size of the magnetic powder is favorably 8 nm or more and 16 nm or less, more favorably 8 nm or more and 13 nm or less, and still more favorably 8 nm or more and 10 nm or less. When the average particle size of the magnetic powder is 16 nm or less, it is possible to achieve more excellent electromagnetic conversion characteristics (e.g., SNR) in the magnetic tape 1 having high recording density. Meanwhile, when the average particle size of the magnetic powder is 8 nm or more, the dispersibility of the magnetic powder is further improved, and it is possible to achieve more excellent electromagnetic conversion characteristics (e.g., SNR). The method of calculating the average particle size of the magnetic powder is similar to the method of calculating the average particle size of the magnetic powder in the case where the magnetic powder includes powder of the ε-iron oxide particles.

In the case where the magnetic powder includes powder of the cobalt ferrite particles, the average aspect ratio of the magnetic powder is favorably 1.0 or more and 3.0 or less, more favorably 1.0 or more and 2.5 or less, and still more favorably 1.0 or more and 2.0 or less. When the average aspect ratio of the magnetic powder is within a range of 1.0 or more and 3.0 or less, it is possible to suppress agglomeration of the magnetic powder. Further, the resistance applied to the magnetic powder when perpendicularly orienting the magnetic powder in the process of forming the magnetic layer 43 can be suppressed. Therefore, it is possible to improve the perpendicular orientation property of the magnetic powder. The method of calculating the average aspect ratio of the magnetic powder is similar to the method of calculating the average aspect ratio of the magnetic powder in the case where the magnetic powder includes powder of the ε-iron oxide particles.

In the case where the magnetic powder includes powder of the cobalt ferrite particles, the average particle volume of the magnetic powder is favorably 500 nm³ or more and 4000 nm³ or less, more favorably 600 nm³ or more and 2000 nm³ or less, and still more favorably 600 nm³ or more and 1000 nm³ or less. When the average particle volume of the magnetic powder is 4000 nm³ or less, an effect similar that in the case where the average particle size of the magnetic powder is 16 nm or less can be achieved. Meanwhile, when the average particle volume of the magnetic powder is 500 nm³ or more, an effect similar to that in the case where the average particle size of the magnetic powder is 8 nm or more can be achieved. The method of calculating the average particle volume of the magnetic powder is similar to the method of calculating the average particle volume in the case where the ε-iron oxide particle has a cubic shape.

(Binder)

Examples of the binder include a thermoplastic resin, a thermosetting resin, and a reactive resin. Examples of the thermoplastic resin include vinyl chloride, vinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-acrylonitrile copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyurethane resin, a polyester resin, an amino resin, and synthetic rubber.

Examples of the thermosetting resin include a phenolic resin, an epoxy resin, a polyurethane curable resin, a urea resin, a melamine resin, an alkyd resin, a silicone resin, a polyamine resin, and a urea-formaldehyde resin.

For the purpose of improving the dispersibility of the magnetic powder, —SO₃M, —OSO₃M, —COOM, P═O(OM)₂ (where M represents a hydrogen atom or an alkali metal such as lithium, potassium, and sodium), a side chain amine having a terminal group represented by —NR1R2, —NR1R2R3⁺X⁻, a main chain amine represented by >NR1R2⁺X⁻ (where R1, R2, and R3 each represent a hydrogen atom or a hydrocarbon group, and X⁻ represents a halogen element ion such as fluorine, chlorine, bromine, and iodine, an inorganic ion, or an organic ion), and a polar functional group such as —OH, —SH, —CN, and an epoxy group may be introduced into all the binders described above. The amount of the polar functional groups introduced into the binders is favorably 10⁻¹ to 10⁻⁸ mol/g, and more favorably 10⁻² to 10⁻⁸ mol/g.

(Lubricant)

The lubricant contains, for example, at least one of a fatty acid or a fatty acid ester, and favorably both a fatty acid and a fatty acid ester. Containing a lubricant in the magnetic layer 43, particularly, containing both a fatty acid and a fatty acid ester in the magnetic layer 43, contributes to improving the travelling stability of the magnetic tape 1. More particularly, when the magnetic layer 43 contains a lubricant and has a pore, favorable travelling stability can be achieved. It is conceivable that the improvement in the travelling stability can be achieved because the dynamic friction coefficient of the surface of the magnetic tape 1 on the side of the magnetic layer 43 is adjusted to the value suitable for travelling of the magnetic tape 1 by the lubricant described above.

The fatty acid may favorably be a compound represented by the following general formula (1) or (2). For example, one of the compound represented by the following general formula (1) and the compound represented by the general formula (2) may be contained as a fatty acid, or both of them may be contained.

Further, the fatty acid ester may favorably be a compound represented by the following general formula (3) or (4). For example, one of the compound represented by the following general formula (3) and the compound represented by the general formula (4) may be contained as the fatty acid ester, or both of them may be contained.

When the lubricant contains one or both of the compound represented by the general formula (1) and the compound represented by the general formula (2) and one or both of the compound represented by the general formula (3) and the compound represented by the general formula (4), it is possible to suppress an increase in dynamic friction coefficient due to repeated recording or reproduction of the magnetic tape 1.

CH₃(CH₂)ₖCOOH (1)

(However, in the general formula (1), k is an integer selected from a range of 14 or more and 22 or less, and more favorably a range of 14 or more and 18 or less.)

CH₃(CH₂)ₙCH═CH(CH₂)ₘCOOH (2)

(However, in the general formula (2), the sum of n and m is an integer selected from a range of 12 or more and 20 or less, and more favorably a range of 14 or more and 18 or less.)

CH₃(CH₂)ₚCOO(CH₂)_{q}CH₃ (3)

(However, in the general formula (3), p is an integer selected from a range of 14 or more and 22 or less, and more favorably a range of 14 or more and 18 or less, and q is an integer selected from a range of 2 or more and 5 or less, and more favorably a range of 2 or more and 4 or less.)

CH₃(CH₂)ᵣCOO—(CH₂)ₛCH(CH₃)₂ (4)

(However, in the general formula (4), r is an integer selected from a range of 14 or more and 22 or less, and s is an integer selected from a range of 1 or more and 3 or less.)

(Antistatic Agent)

Examples of the antistatic agent include carbon black, natural surfactant, nonionic surfactant, and cationic surfactant.

(Abrasive)

Examples of the abrasive include α-alumina, β-alumina, and γ-alumina having an α-transformation rate of 90% or more, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating a raw material of magnetic iron oxide and performing annealing treatment thereon, and those obtained by performing surface treatment on them with aluminum and/or silica as necessary.

(Curing Agent)

Examples of the curing agent include a polyisocyanate. Examples of the polyisocyanate include an aromatic polyisocyanate such as an adduct of tolylene diisocyanate (TDI) and an active hydrogen compound, and an aliphatic polyisocyanate such as an adduct of hexamethylene diisocyanate (HMDI) and an active hydrogen compound. The weight average molecular weight of the polyisocyanates is desirably in a range of 100 to 3000.

(Rust Inhibitor)

Examples of the rust inhibitor include phenols, naphthols, quinones, a heterocyclic compound containing a nitrogen atom, a heterocyclic compound containing an oxygen atom, and a heterocyclic compound containing a sulfur atom.

(Non-Magnetic Reinforcing Particle)

Examples of the non-magnetic reinforcing particle include aluminum oxide (α, β, or γ alumina), chromium oxide, silicon oxide, diamond, garnet, emery, boron nitride, titanium carbide, silicon carbide, titanium carbide, and titanium oxide (rutile or anatase titanium oxide).

(Underlayer)

The underlayer 42 is for reducing the recesses and projections on the surface of the base material 41 and adjusting the recesses and projections on the surface of the magnetic layer 43. The underlayer 42 is a non-magnetic layer containing a non-magnetic powder, a binder, and a lubricant. The underlayer 42 supplies the lubricant to the surface of the magnetic layer 43. The underlayer 42 may further contain at least one additive of an antistatic agent, a curing agent, a rust inhibitor, or the like as necessary.

An average thickness t₂ of the underlayer 42 is favorably 0.3 μm or more and 1.2 μm or less, more favorably 0.3 μm or more and 0.9 μm or less, and 0.3 μm or more and 0.6 μm or less. Note that the average thickness t₂ of the underlayer 42 is obtained in a way similar to that for the average thickness t₁ of the magnetic layer 43. However, the magnification of the TEM image is adjusted as appropriate in accordance with the thickness of the underlayer 42. When the average thickness t₂ of the underlayer 42 is 1.2 μm or less, the stretchability of the magnetic tape 1 due to external force further increases, and thus, adjustment of the width of the magnetic tape 1 by tension adjustment becomes easier.

(Non-Magnetic Powder)

The non-magnetic powder includes, for example, at least one of inorganic particle powder or organic particle powder. Further, the non-magnetic powder may include carbon powder such as carbon black. Note that one type of non-magnetic powder may be used alone or two or more types of non-magnetic powder may be used in combination. The inorganic particles contain, for example, a metal, a metal oxide, a metal carbonate, a metal sulfate, a metal nitride, a metal carbide, a metal sulfide, or the like. Examples of the shape of the non-magnetic powder include, but not limited to, various shapes such as a needle shape, a spherical shape, a cubic shape, and a plate shape.

(Binder and Lubricant)

The binder and the lubricant are similar to those of the magnetic layer 43 described above.

(Additive)

The antistatic agent, the curing agent, and the rust inhibitor are similar to those of the magnetic layer 43 described above.

(Back Layer)

The back layer 44 contains a binder and non-magnetic powder. The back layer 44 may further contain at least one additive of a lubricant, a curing agent, an antistatic agent, or the like as necessary. The binder and the non-magnetic powder are similar to those of the underlayer 42 described above.

The average particle size of the non-magnetic powder is favorably 10 nm or more and 150 nm or less, and more favorably 15 nm or more and 110 nm or less. The average particle size of the non-magnetic powder is obtained in a way similar to that for the average particle size of the magnetic powder described above. The non-magnetic powder may include non-magnetic powder having two or more granularity distributions.

The upper limit value of the average thickness of the back layer 44 is favorably 0.6 μm or less. When the upper limit value of the average thickness of the back layer 44 is 0.6 μm or less, the underlayer 42 and the base material 41 can be kept thick even in the case where the average thickness of the magnetic tape 1 is 5.6 μm or less, and thus, it is possible to maintain the travelling stability of the magnetic tape 1 in the recording/reproduction apparatus. The lower limit value of the average thickness of the back layer 44 is not particularly limited, but is, for example, 0.2 μm or more.

An average thickness t_{b} of the back layer 44 is obtained as follows. First, an average thickness t_{T} of the magnetic tape 1 is measured. The measurement method of the average thickness t_{T} is as described in the following “Average thickness of magnetic tape”. Subsequently, the magnetic tape 1 housed in the cartridge case 10 is unwound and the magnetic tape 1 is cut into a length of 250 mm at the position between 30 m or more and +10 m in the longitudinal direction from the connection portion between the magnetic tape 1 and the leader pin 50 to prepare a sample. Next, the back layer 44 of the sample is removed with a solvent such as MEK (methyl ethyl ketone) and dilute hydrochloric acid. Next, a Laser Hologage (LGH-110C) manufactured by Mitutoyo Corporation is used to measure the thickness of the sample at five or more positions, and the measured values are simply averaged (arithmetically averaged) to calculate an average value t_{B} [μm]. After that, the average thickness t_{b} [μm] of the back layer 44 is obtained in accordance with the following formula. Note that the five measurement positions described above are randomly selected from the sample such that they are different positions in the longitudinal direction of the magnetic tape 1. The measurement positions are randomly selected from the sample.

t_{b}[μm]=t_{T}[μm]−t_{B}[μm]

The back layer 44 has a surface provided with numerous protruding portions. The numerous protruding portions are for forming numerous hole portions in the surface of the magnetic layer 43 under a state in which the magnetic tape 1 has been wound in a roll shape. The numerous hole portions are formed by numerous non-magnetic particles protruding from the surface of the back layer 44, for example.

(Average Thickness of Magnetic Tape)

The upper limit value of the average thickness (average total thickness) t_{T} of the magnetic tape 1 is favorably 5.2 μm or less, more favorably 5.0 μm or less, still more favorably 4.6 μm or less, and particularly favorably 4.4 μm or less. When the average thickness t_{T} of the magnetic tape 1 is 5.2 μm or less, it is possible to make the recording capacity of a single data cartridge larger than that of a general magnetic tape. The lower limit value of the average thickness t_{T} of the magnetic tape 1 is not particularly limited, but is, for example, 3.5 μm or more.

The average thickness t_{T} of the magnetic tape 1 is obtained as follows. First, the magnetic tape 1 housed in the cartridge case 10 is unwound and the magnetic tape 1 is cut into a length of 250 mm at the position between 30 m or more and +10 m in the longitudinal direction from the connection portion between the magnetic tape 1 and the leader pin 50 to prepare a sample. Next, a Laser Hologage (LGH-110C) manufactured by Mitutoyo Corporation is used as a measuring apparatus to measure the thickness of the sample at five positions, and the measured values are simply averaged (arithmetically averaged) to calculate an average thickness t_{T} [μm]. Note that the five measurement positions described above are randomly selected from the sample such that they are different positions in the longitudinal direction of the magnetic tape 1.

(Coercive Force Hc)

The upper limit value of a coercive force Hc2 of the magnetic layer 43 in the longitudinal direction of the magnetic tape 1 is favorably 2000 Oe or less, more favorably 1900 Oe or less, and still more favorably 1800 Oe or less. When the coercive force Hc2 of the magnetic layer 43 in the longitudinal direction is 2000 Oe or less, sufficient electromagnetic conversion characteristics can be provided even with high recording density.

The lower limit value of the coercive force Hc2 of the magnetic layer 43 measured in the longitudinal direction of the magnetic tape 1 is favorably 1000 Oe or more. When the coercive force Hc2 of the magnetic layer 43 measured in the longitudinal direction is 1000 Oe or more, it is possible to suppress demagnetization due to leakage flux from the recording head.

The coercive force Hc2 described above is obtained as follows. First, the magnetic tape 1 housed in the cartridge case 10 is unwound, the magnetic tape 1 is cut out at the position between 30 m or more and +10 m in the longitudinal direction from the connection portion between the magnetic tape 1 and the leader pin 50, and three magnetic tapes 1 are superimposed with double sided tape such that the orientations of the magnetic tapes 1 in the longitudinal direction are the same, and then punched out with a punch of φ6.39 mm to prepare a measurement sample. At this time, marking is performed with arbitrary non-magnetic ink such that the longitudinal direction (travelling direction) of the magnetic tape 1 can be recognized. Then, a vibrating sample magnetometer (VSM) is used to measure the M-H loop of the measurement sample (the entire magnetic tape 1) corresponding to the longitudinal direction (travelling direction) of the magnetic tape 1. Next, acetone, ethanol, or the like is used to wipe off the coating film (the underlayer 42, the magnetic layer 43, the back layer 44, and the like) of the magnetic tape 1 cut as described above, leaving only the base material 41. Then, three obtained base materials 41 are superimposed with double sided tape, and then punched out with a punch of φ6.39 mm to prepare a sample for background correction (hereinafter, referred to simply as “correction sample”). After that, the M-H loop of the correction sample (base material 41) corresponding to the longitudinal direction of the base material 41 (longitudinal direction of the magnetic tape 1) is measured using the VSM.

In the measurement of the M-H loop of the measurement sample (the entire magnetic tape 1) and the M-H loop of the correction sample (base material 41), a High Sensitivity Vibrating Sample Magnetometer “VSM-P7-15” manufactured by TOEI INDUSTRY CO., LTD. is used. The measurement conditions are the measurement mode: full-loop, the maximum magnetic field: 15 kOe, the magnetic field step: 40 bits, the time constant of locking amp: 0.3 sec, the waiting time: 1 sec, and the MH average number: 20.

After the M-H loop of the measurement sample (the entire magnetic tape 1) and the M-H loop of the correction sample (base material 41) are obtained, the M-H loop of the correction sample (base material 41) is subtracted from the M-H loop of the measurement sample (the entire magnetic tape 1) to perform background correction, thereby obtaining the M-H loop after background correction. A measurement/analysis program attached to the “VSM-P7-15” is used for this calculation of background correction. The coercive force Hc2 is obtained on the basis of the obtained M-H loop after background correction. Note that the measurement/analysis program attached to the “VSM-P7-15” is used for this calculation. Note that the measurement of the M-H loop described above is performed at 25° C.±2° C. and 50% RH±5% RH. Further, the “demagnetizing field correction” in measuring the M-H loop in the longitudinal direction of the magnetic tape 1 is not performed.

(Squareness Ratio)

A squareness ratio S1 of the magnetic layer 43 in the perpendicular direction (thickness direction) of the magnetic tape 1 is favorably 65% or more, more favorably 70% or more, still more favorably 75% or more, particularly favorably 80% or more, and most favorably 85% or more. When the squareness ratio S1 is 65% or more, the perpendicular orientation property of the magnetic powder is sufficiently high, and thus, it is possible to achieve more excellent electromagnetic conversion characteristics (e.g., SNR).

The squareness ratio S1 of the magnetic tape 1 in the perpendicular direction is obtained as follows. First, the magnetic tape 1 housed in the cartridge case 10 is unwound, the magnetic tape 1 is cut out at the position between 30 m or more and +10 m in the longitudinal direction from the connection portion between the magnetic tape 1 and the leader pin 50, and three magnetic tapes 1 are superimposed with double sided tape such that the orientations of the magnetic tapes 1 in the longitudinal direction are the same, and then punched out with a punch of φ6.39 mm to prepare a measurement sample. At this time, marking is performed with arbitrary non-magnetic ink such that the longitudinal direction (travelling direction) of the magnetic tape 1 can be recognized. Then, the M-H loop of the measurement sample (the entire magnetic tape 1) corresponding to the perpendicular direction of the magnetic tape 1 (perpendicular direction of the magnetic tape 1) is measured using a vibrating sample magnetometer (VSM). Next, acetone, ethanol, or the like is used to wipe off the coating film (the underlayer 42, the magnetic layer 43, the back layer 44, and the like) of the magnetic tape 1 cut as described above, leaving only the base material 41. Then, three obtained base materials 41 are superimposed with double sided tape, and then punched out with a punch of φ6.39 mm to prepare a sample for background correction (hereinafter, referred to simply as “correction sample”). After that, the M-H loop of the correction sample (base material 41) corresponding to the perpendicular direction of the base material 41 (perpendicular direction of the magnetic tape 1) is measured using the VSM.

In the measurement of the M-H loop of the measurement sample (the entire magnetic tape 1) and the M-H loop of the correction sample (base material 41), a High Sensitivity Vibrating Sample Magnetometer “VSM-P7-15” manufactured by TOEI INDUSTRY CO., LTD. is used. The measurement conditions are the measurement mode: full-loop, the maximum magnetic field: 15 kOe, the magnetic field step: 40 bits, the time constant of locking amp: 0.3 sec, the waiting time: 1 sec, and the MH average number: 20.

After the M-H loop of the measurement sample (the entire magnetic tape 1) and the M-H loop of the correction sample (base material 41) are obtained, the M-H loop of the correction sample (base material 41) is subtracted from the M-H loop of the measurement sample (the entire magnetic tape 1) to perform background correction, thereby obtaining the M-H loop after background correction. The measurement/analysis program attached to the “VSM-P7-15” is used for this calculation of background correction.

A saturation magnetization Ms (emu) and a residual magnetization Mr (emu) of the obtained M-H loop after background correction are substituted into the following formula to calculate the squareness ratio S1 (%). Note that the measurement of the M-H loop described above is performed at 25° C.±2° C. and 50% RH±5% RH. Further, the “demagnetizing field correction” in measuring the M-H loop in the perpendicular direction of the magnetic tape 1 is not performed. Note that the measurement/analysis program attached to the “VSM-P7-15” is used for this calculation.

Squareness ratio S1(%)=(Mr/Ms)×100

A squareness ratio S2 of the magnetic layer 43 in the longitudinal direction (travelling direction) of the magnetic tape 1 is favorably 35% or less, more favorably 30% or less, still more favorably 25% or less, particularly favorably 20% or less, and most favorably 15% or less. When the squareness ratio S2 is 35% or less, the perpendicular orientation property of the magnetic powder is sufficiently high, and thus, it is possible to achieve more excellent electromagnetic conversion characteristics (e.g., SNR).

The squareness ratio S2 in the longitudinal direction is obtained in a way similar to that for the squareness ratio S1 except for measuring the M-H loop in the longitudinal direction (travelling direction) of the magnetic tape 1 and the base material 41.

(Surface Roughness R_{b} of Back Surface)

A surface roughness R_{b} of the back surface (surface roughness of the back layer 44) is favorably R_{b}≤6.0 [nm]. When the surface roughness R_{b} of the back surface is within the range described above, it is possible to achieve more excellent electromagnetic conversion characteristics.

The surface roughness R_{b} of the back surface is obtained as follows. First, the magnetic tape 1 housed in the cartridge case 10 is unwound and the magnetic tape 1 is cut into a length of 100 mm at the position of 30 m in the longitudinal direction from the connection portion between the magnetic tape 1 and the leader pin 50 to prepare a sample. Next, the sample is placed on a slide glass such that the surface to be measured of the sample (surface on the magnetic layer side) faces up, and the end portion of the sample is fixed with mending tape. The surface shape is measured using VertScan (objective lens 20×) as a measuring apparatus and the surface roughness R_{b} of the back surface is obtained from the following formula on the basis of the ISO 25178 standard.

The measurement conditions are as follows.
Apparatus: Non-contact profilometer using optical interference
   (non-contact surface/layer cross-sectional shape measurement system VertScan R5500GL-M100-AC manufactured by Ryoka Systems Inc.)
Objective lens: 20×
Measurement region: 640×480 pixels (field of
view: approximately 237 μm×178 μm field of view)
Measurement mode: phase
Wavelength filter: 520 nm
CCD: ⅓ inch
Noise removal filter: smoothing 3×3
Surface correction: corrected by quadratic polynomial approximation surface
Measurement software: VS-Measure Version5.5.2
Analysis software: VS-viewer Version5.5.5

$${S}_{a} = \frac{1}{A} \int {\int }_{A} \vert Z ( x , y ) \vert dxdy \qquad [ Math . 2 ]$$

After measuring the surface roughness at five positions in the longitudinal direction of the magnetic tape 1 as described above, the average value of arithmetic average roughnesses Sa (nm) automatically calculated from the surface profile obtained at the respective positions is used as the surface roughness R_{b} (nm) of the back surface.

The upper limit value of the Young's modulus of the magnetic tape 1 in the longitudinal direction is favorably 9.0 GPa or less, more favorably 8.0 GPa or less, still more favorably 7.5 GPa or less, and particularly favorably 7.1 GPa or less. When the Young's modulus of the magnetic tape 1 in the longitudinal direction is 9.0 GPa or less, the stretchability of the magnetic tape 1 due to external force further increases, and thus, adjustment of the width of the magnetic tape 1 by tension adjustment becomes easier. Therefore, it is possible to more appropriately suppress the off-track and more accurately reproduce the data recorded on the magnetic tape 1. The lower limit value of the Young's modulus of the magnetic tape 1 in the longitudinal direction is favorably 3.0 GPa or more and more favorably 4.0 GPa or more. When the lower limit value of the Young's modulus of the magnetic tape 1 in the longitudinal direction is 3.0 GPa or more, it is possible to suppress deterioration of the travelling stability.

The Young's modulus of the magnetic tape 1 in the longitudinal direction is a value indicating the difficulty of expansion and contraction of the magnetic tape 1 in the longitudinal direction due to external force. The larger this value, the more difficult it is for the magnetic tape 1 to expand and contract in the longitudinal direction due to external force. The smaller this value, the easier it is for the magnetic tape 1 to expand and contract in the longitudinal direction due to external force.

Note that the Young's modulus of the magnetic tape 1 in the longitudinal direction is a value relating to the magnetic tape 1 in the longitudinal direction, but is also correlated with the difficulty of expansion and contraction of the magnetic tape 1 in the width direction. That is, the larger this value, the more difficult it is for the magnetic tape 1 to expand and contract in the width direction due to external force. The smaller this value, the easier it is for the magnetic tape 1 to expand and contract in the width direction due to external force. Therefore, from the viewpoint of tension adjustment, it is advantageous that the Young's modulus of the magnetic tape 1 in the longitudinal direction is small, i.e., 9.0 GPa or less, as described above.

A tensile tester (manufactured by Shimadzu Corporation, AG-100D) is used to measure the Young's modulus. In order to measure the Young's modulus in the tape longitudinal direction, the magnetic tape 1 housed in the cartridge case 10 is unwound and the magnetic tape 1 is cut into a length of 180 mm at the position between 30 m or more and +10 m in the longitudinal direction from the connection portion between the magnetic tape 1 and the leader pin 50 to prepare a measurement sample. A jig capable of fixing the width of the tape (½ inch) is attached to the tensile tester described above to fix the top and bottom of the tape width. The distance (length of the tape between chucks) is set to 100 mm. After the tape sample is chucked, stress is gradually applied in the direction in which the sample is pulled. The pulling speed is set to 0.1 mm/min. From the change in the stress and the amount of elongation at this time, the Young's modulus is calculated using the following formula.

E(N/m²)=((ΔN/S)/(Δx/L))×10⁶
ΔN: change in stress (N)
S: cross-sectional area of test piece (mm²)
Δx: amount of elongation (mm)
L: distance between gripping jigs (mm)

The cross-sectional area S of a measurement sample 10S is the cross-sectional area before the tensile operation and is obtained by multiplying the width of the measurement sample 10S (½ inch) by the thickness of the measurement sample 10S. Regarding the range of the tensile stress when performing measurement, a range of tensile stress in the linear region is set in accordance with the thickness of the magnetic tape 1 and the like. Here, the range of stress is set to 0.5 N to 1.0 N, and the change in stress (ΔN) and the amount of elongation (Δx) at this time are used for calculation. Note that the measurement of the Young's modulus described above is performed at 25° C.±2° C. and 50% RH±5% RH.

(Young's Modulus of Base Material in Longitudinal Direction)

The Young's modulus of the base material 41 in the longitudinal direction is favorably 7.8 GPa or less, more favorably 7.0 GPa or less, still more favorably 6.6 GPa or less, and particularly favorably 6.4 GPa or less. When the Young's modulus of the base material 41 in the longitudinal direction is 7.8 GPa or less, the stretchability of the magnetic tape 1 due to external force further increases, and thus, adjustment of the width of the magnetic tape 1 by tension adjustment becomes easier. Therefore, it is possible to more appropriately suppress the off-track and more accurately reproduce the data recorded on the magnetic tape 1. The lower limit value of the Young's modulus of the base material 41 in the longitudinal direction is favorably 2.5 GPa or more and more favorably 3.0 GPa or more. When the lower limit value of the Young's modulus of the base material 41 in the longitudinal direction is 2.5 GPa or more, it is possible to suppress deterioration of the travelling stability.

The Young's modulus of the base material 41 in the longitudinal direction described above is obtained as follows. First, the magnetic tape 1 housed in the cartridge case 10 is unwound and the magnetic tape 1 is cut into a length of 180 mm at the position between 30 m or more and +10 m in the longitudinal direction from the connection portion between the magnetic tape 1 and the leader pin 50. Subsequently, the underlayer 42, the magnetic layer 43, and the back layer 44 are removed from the cut magnetic tape 1 to obtain the base material 41. This base material 41 is used to obtain the Young's modulus of the base material 41 in the longitudinal direction by the procedure similar to that for the Young's modulus of the magnetic tape 1 in the longitudinal direction described above.

The thickness of the base material 41 occupies half or more of the total thickness of the magnetic tape 1. Therefore, the Young's modulus of the base material 41 in the longitudinal direction is correlated with the difficulty of expansion and contraction of the magnetic tape 1 due to external force. The larger this value, the more difficult it is for the magnetic tape 1 to expand and contract in the width direction due to external force. The smaller this value, the easier it is for the magnetic tape 1 to expand and contract in the width direction due to external force.

Note that Note that the Young's modulus of the base material 41 in the longitudinal direction is a value relating to the magnetic tape 1 in the longitudinal direction, but is also correlated with the difficulty of expansion and contraction of the magnetic tape 1 in the width direction. That is, the larger this value, the more difficult it is for the magnetic tape 1 to expand and contract in the width direction due to external force. The smaller this value, the easier it is for the magnetic tape 1 to expand and contract in the width direction due to external force. Therefore, from the viewpoint of tension adjustment, it is advantageous that the Young's modulus of the base material 41 in the longitudinal direction is small, i.e., 7.8 GPa or less, as described above.

It should be noted that the present technology may also take the following configurations.
(1) A tape cartridge, including:
   a first tape reel;
   a magnetic tape that is wound around the first tape reel;
   a leader pin that is attached to an end portion of the magnetic tape and includes a shaft portion parallel to a tape width direction; and
   a second tape reel that includes a cylindrical reel hub, a first flange, and a second flange, the cylindrical reel hub having an inner peripheral surface and an outer peripheral surface, a housing unit capable of housing the leader pin being provided on the inner peripheral surface or the outer peripheral surface, the first flange being provided to one end portion of the reel hub, the second flange being provided to the other end portion of the reel hub and including a slit portion through which the magnetic tape is capable of passing.
(2) The tape cartridge according to (1) above, in which
   the leader pin further includes enlarged diameter portions that are provided at both end portions of the shaft portion and have an outer diameter larger than a dimeter of the shaft portion, and
   the housing unit includes a recessed groove portion capable of housing the leader pin and engaging portions capable of engaging with the enlarged diameter portions in an axial direction of the reel hub.
(3) The tape cartridge according to (2) above, in which
   the housing unit is provided on the inner peripheral surface, and
   the housing unit further includes a passage portion that communicates between the recessed groove portion and the outer peripheral surface, the magnetic tape being capable of passing through the passage portion.
(4) The tape cartridge according to (3) above, in which
   the second flange further includes a central hole concentric with the reel hub, and
   the slit portion is linearly formed in a radial direction from the central hole to an outer peripheral edge portion of the second flange.
(5) The tape cartridge according to (3) or (4) above, in which
   the reel hub further includes a curved surface portion formed at a boundary between the passage portion and the outer peripheral surface.
(6) The tape cartridge according to (5) above, in which
   a radius of curvature of a circular arc forming the curved surface portion is 0.1 mm or more.
(7) The tape cartridge according to (2) above, in which
   the housing unit is provided on the outer peripheral surface, and
   the slit portion is linearly formed in a radial direction of the second flange to have a width that allows the leader pin to pass through the slit portion.
(8) The tape cartridge according to (7) above, in which
   the first flange further includes a slit portion that is linearly formed in the radial direction of the second flange to have a width that allows the leader pin to pass through the slit portion, and
   the slit portion of the first flange and the slit portion of the second flange are disposed to face each other in the axial direction.
(9) The tape cartridge according to (8) or (9) above, in which
   the reel hub further includes a curved surface portion formed at a boundary between the housing unit and the outer peripheral surface.
(10) The tape cartridge according to (9) above, in which
   a radius of curvature of a circular arc forming the curved surface portion is 0.1 mm or more.
(11) The tape cartridge according to any one of (2) to (10) above, in which
   the recessed groove portion is formed to have a depth larger than a maximum outer diameter of the leader pin.
(12) The tape cartridge according to any one of (1) to (11) above, in which
   a surface roughness of the outer peripheral surface is 12 μm or less in Rz and 2 μm or less in Ra.
(13) The tape cartridge according to any one of (1) to (12) above, in which
   an inner surface of the first flange and an inner surface of the second flange are inclined surfaces that are inclined in a direction in which a distance between the inner surfaces gradually increases radially outward of the second tape reel, and have inclination gradients of 2 μm/mm or more.
(14) The tape cartridge according to any one of (1) to (13) above, in which
   a magnetic layer of the magnetic tape is a coating film of a sputtering film of a magnetic material.
(15) The tape cartridge according to any one of (1) to (14) above, in which
   an average thickness of the magnetic tape is 5.6 μm or less.
(16) The tape cartridge according to any one of (1) to (15) above, further including:
   a cartridge case that houses the first tape reel and the second tape reel;
   a support member that is disposed inside a reel hub of the first tape reel and abuts on a tip portion of a drive shaft of a recording/reproduction apparatus inserted through the reel hub of the first tape reel; and
   an elastic member that is disposed between the support member and the cartridge case and presses the support member toward the tip portion of the drive shaft.
(17) The tape cartridge according to (16) above, in which
   the cartridge case includes a guide unit that supports the support member so as to be movable in an axial direction of the reel hub of the first tape reel.
(18) The tape cartridge according to (16) or (17) above, in which
   the support member includes a hemispherical abutting portion capable of abutting on the tip portion of the drive shaft.
(19) A method of producing a tape cartridge, including:
   winding a magnetic tape around a first tape reel;
   disposing the magnetic tape between a first flange portion and a second flange portion of a second tape reel through a slit portion formed in the first flange portion;
   housing a leader pin in a housing unit formed on an inner peripheral surface or an outer peripheral surface of a reel hub of the second tape reel, the leader pin being attached to an end portion of the magnetic tape; and
   winding the magnetic tape around the reel hub of the second tape reel.
(20) A tape reel, including:
   a cylindrical reel hub that has an inner peripheral surface and an outer peripheral surface, a housing unit capable of housing a leader pin being provided on the inner peripheral surface or the outer peripheral surface, the leader pin being attached to an end portion of a magnetic tape;
   a first flange that is provided to one end portion of the reel hub; and
   a second flange that is provided to the other end portion of the reel hub and includes a slit portion through which the magnetic tape is capable of passing.

### REFERENCE SIGNS LIST

1 magnetic tape
10 cartridge case
21 first tape reel
22, 22A second tape reel
50 leader pin
60, 61 housing unit
71 support member
72 elastic member
100, 300 tape cartridge
210, 220 reel hub
211, 221 lower flange
211p slit portion
212,222 upper flange
222s,222p slit portion
601,611 recessed groove portion
602 passage portion
DS reel drive shaft

1. A tape cartridge, comprising:
a first tape reel;
a magnetic tape that is wound around the first tape reel;
a leader pin that is attached to an end portion of the magnetic tape and includes a shaft portion parallel to a tape width direction; and
a second tape reel that includes a cylindrical reel hub, a first flange, and a second flange, the cylindrical reel hub having an inner peripheral surface and an outer peripheral surface, a housing unit capable of housing the leader pin being provided on the inner peripheral surface or the outer peripheral surface, the first flange being provided to one end portion of the reel hub, the second flange being provided to the other end portion of the reel hub and including a slit portion through which the magnetic tape is capable of passing.

2. The tape cartridge according to claim 1, wherein
the leader pin further includes enlarged diameter portions that are provided at both end portions of the shaft portion and have an outer diameter larger than a dimeter of the shaft portion, and
the housing unit includes a recessed groove portion capable of housing the leader pin and engaging portions capable of engaging with the enlarged diameter portions in an axial direction of the reel hub.

3. The tape cartridge according to claim 2, wherein
the housing unit is provided on the inner peripheral surface, and
the housing unit further includes a passage portion that communicates between the recessed groove portion and the outer peripheral surface, the magnetic tape being capable of passing through the passage portion.

4. The tape cartridge according to claim 3, wherein
the second flange further includes a central hole concentric with the reel hub, and
the slit portion is linearly formed in a radial direction from the central hole to an outer peripheral edge portion of the second flange.

5. The tape cartridge according to claim 3, wherein
the reel hub further includes a curved surface portion formed at a boundary between the passage portion and the outer peripheral surface.

6. The tape cartridge according to claim 5, wherein
a radius of curvature of a circular arc forming the curved surface portion is 0.1 mm or more.

7. The tape cartridge according to claim 2, wherein
the housing unit is provided on the outer peripheral surface, and
the slit portion is linearly formed in a radial direction of the second flange to have a width that allows the leader pin to pass through the slit portion.

8. The tape cartridge according to claim 7, wherein
the first flange further includes a slit portion that is linearly formed in the radial direction of the second flange to have a width that allows the leader pin to pass through the slit portion, and
the slit portion of the first flange and the slit portion of the second flange are disposed to face each other in the axial direction.

9. The tape cartridge according to claim 7, wherein
the reel hub further includes a curved surface portion formed at a boundary between the housing unit and the outer peripheral surface.

10. The tape cartridge according to claim 9, wherein
a radius of curvature of a circular arc forming the curved surface portion is 0.1 mm or more.

11. The tape cartridge according to claim 2, wherein
the recessed groove portion is formed to have a depth larger than a maximum outer diameter of the leader pin.

12. The tape cartridge according to claim 1, wherein
a surface roughness of the outer peripheral surface is 12 μm or less in Rz and 2 μm or less in Ra.

13. The tape cartridge according to claim 1, wherein
an inner surface of the first flange and an inner surface of the second flange are inclined surfaces that are inclined in a direction in which a distance between the inner surfaces gradually increases radially outward of the second tape reel, and have inclination gradients of 2 μm/mm or more.

14. The tape cartridge according to claim 1, wherein
a magnetic layer of the magnetic tape is a coating film of a sputtering film of a magnetic material.

15. The tape cartridge according to claim 1, wherein
an average thickness of the magnetic tape is 5.6 μm or less.

16. The tape cartridge according to claim 1, further comprising:
a cartridge case that houses the first tape reel and the second tape reel;
a support member that is disposed inside a reel hub of the first tape reel and abuts on a tip portion of a drive shaft of a recording/reproduction apparatus inserted through the reel hub of the first tape reel; and
an elastic member that is disposed between the support member and the cartridge case and presses the support member toward the tip portion of the drive shaft.

17. The tape cartridge according to claim 16, wherein
the cartridge case includes a guide unit that supports the support member so as to be movable in an axial direction of the reel hub of the first tape reel.

18. The tape cartridge according to claim 16, wherein
the support member includes a hemispherical abutting portion capable of abutting on the tip portion of the drive shaft.

19. A method of producing a tape cartridge, comprising:
winding a magnetic tape around a first tape reel;
disposing the magnetic tape between a first flange portion and a second flange portion of a second tape reel through a slit portion formed in the first flange portion;
housing a leader pin in a housing unit formed on an inner peripheral surface or an outer peripheral surface of a reel hub of the second tape reel, the leader pin being attached to an end portion of the magnetic tape; and
winding the magnetic tape around the reel hub of the second tape reel.

20. A tape reel, comprising:
a cylindrical reel hub that has an inner peripheral surface and an outer peripheral surface, a housing unit capable of housing a leader pin being provided on the inner peripheral surface or the outer peripheral surface, the leader pin being attached to an end portion of a magnetic tape;
a first flange that is provided to one end portion of the reel hub; and
a second flange that is provided to the other end portion of the reel hub and includes a slit portion through which the magnetic tape is capable of passing.
